(19) United States
(12) Patent Application Publication
(10) Pub. No.: US 2011/0197040 A1
(43) Pub. Date: Aug. 11, 2011

(54) STORAGE SYSTEM AND STORAGE CONTROL METHOD

(75) Inventors: Naruhiro OOGAI, Kawasaki (JP); Yasuyuki NAKATA, Kawasaki (JP); Yoshinari SHINOZAKI, Kawasaki (JP)

(73) Assignee: FUJITSU LIMITED, Kawasaki-shi (JP)

(21) Appl. No.: 13/008,077

(22) Filed: Jan. 18, 2011

(30) Foreign Application Priority Data
Feb. 5, 2010 (JP) 2010-024846

(51) Int. Cl. G06F 12/16

(52) U.S. Cl. 711/162; 711/E12.103

(57) ABSTRACT

A storage system to copy data from a copying origin to a copying destination. The storage system includes a storing area creating unit. The storing area creating unit causes a storing unit in a storage to create a status information storing area to have status information stored therein, based on grouping, the grouping being executed on data that is divided into plural pieces, the grouping being executed when the divided data is stored in the storage. The status information of each group is stored in the status information storing area that is created by the storing unit.

### CROSS-REFERENCE TO RELATED APPLICATION

This application is based upon and claims the benefit of priority of the prior Japanese Patent Application No. 2010-024846, filed on Feb. 5, 2010, the entire contents of which are incorporated herein by reference.

### FIELD

The embodiments discussed herein are related to copying control of data between storage apparatuses that each store data in a plurality of volumes etc., dividing the data into pieces, and, for example, to a storage system and a storage control method that group pieces of copied data and manage the copied data using each storage.

### BACKGROUND

A storage system has a remote equivalent copying (REC) function of copying data of all or some of volumes from a copying origin apparatus to a copying destination apparatus as its function of transferring data between different storage apparatuses. This REC function acts to transfer data within a designated range from a copying origin apparatus to a copying destination apparatus in response to a start command received from a host, in the form of sequential transfer of the data from the head to the tail of its designated range. This is referred to as “initial copying”. Using the REC function, by also transferring to the copying destination apparatus the data that is written in an area whose initial copying has been completed, the data at the copying origin apparatus and the data at the copying destination apparatus are kept equivalent to each other.

With the REC function equipped in the storage system, a storage apparatus can directly transfer data through no host. Therefore, a CPU (Central Processing Unit) of the host is relieved from data transfer and, therefore, the load on the host is reduced.

As to the REC function, to define a group to maintain the consistency of data (Japanese Laid-Open Patent Publication No. 2002-189570) and to assure the time sequence of data in remote copying (Japanese Laid-Open Patent Publication No. 2008-181288) are known.

### SUMMARY

According to an aspect of the invention, a storage system copies data from a copying origin to a copying destination. The storage system includes a storing area creating unit. The storing area creating unit causes a storing unit in a storage to create a status information storing area to have status information stored therein, based on grouping, the grouping being executed on data that is divided into plural pieces, the grouping being executed when the divided data is stored in the storage. The status information of each group is stored in the status information storing area that is created by the storing unit.

The object and advantages of the invention will be realized and attained by means of the elements and combinations particularly pointed out in the claims.

Other objects, features and advantages of the present invention will become more apparent with reference to each embodiment and accompanying drawings.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an exemplary configuration of a storage system according to a first embodiment;

FIG. 2 is a flowchart of an example of a storage control method according to the first embodiment;

FIG. 3 is a diagram of an example of functional units of a storage system according to a second embodiment;

FIG. 4 is a diagram of an exemplary hardware configuration of the storage system according to the second embodiment;

FIG. 5 is a diagram of an exemplary configuration of a memory;

FIG. 6 is a diagram of an exemplary configuration of a copying session management table;

FIG. 7 is a diagram of volume statuses and the meanings thereof;

FIG. 8 is a diagram of an exemplary configuration of a consistency status table;

FIG. 9 is a diagram of a status transition of consistency management of a copying session group;

FIG. 10 is a diagram of group statuses and the meanings thereof;

FIG. 11 is a flowchart of an example of a process procedure of a status changing process;

FIG. 12 is a flowchart of a process procedure of a status checking process;

FIG. 13 is a flowchart of a process procedure for changing a group status;

FIG. 14 is a flowchart of a process procedure for changing a group status in “Session Create/Resume”;

FIG. 15 is a flowchart of a process procedure for changing the group status during a deleting process;

FIG. 16 is a flowchart of a process procedure for changing the group status of a “Session Suspend” process;

FIG. 17 is a flowchart of a process procedure for changing the group status in “Session Equivalent (completion of initial copying)”;

FIG. 18 is a diagram of an example of a log processing system between a copying origin site and a copying destination site;

FIG. 19 is a flowchart of an example of a process procedure of a log recording process;

FIG. 20 is a diagram of a synchronized transferring status;

FIG. 21 is a diagram of a synchronized transferring suspension status;

FIG. 22 is a diagram of collection of backup data;

FIG. 23 is a diagram of a data mismatching status;

FIG. 24 is a diagram of the data mismatching status at the time when a copying origin housing suffers from a disaster;

FIG. 25 is a diagram of the data mismatching status;

FIG. 26 is a diagram of a no-session status;

FIG. 27 is a diagram of the no-session status as a result of resuming of a duty by the copying destination housing;

FIG. 28 is a flowchart of an example of process sequence executed between a host and a storage;

FIG. 29 is a diagram of a comparative example of a storage system that has no consistency table;

FIG. 30 is a flowchart of a process procedure of a secondary backup;

FIG. 31 is a diagram of backing up by REC;

FIG. 32 is a diagram of a process executed when a failure has occurred to some of volumes;

FIG. 33 is a diagram of a state where consistency of a group is assured;

FIG. 34 is a diagram of the state where a failure occurs;

FIG. 35 is a diagram of a baking-up process;

FIG. 36 is a diagram of recovery of a failed disk;

FIG. 37 is a diagram of replacement of a failed copying origin volume;

FIG. 38 is a diagram of a recovering process for backed-up data;

FIG. 39 is a diagram of a recovery operation;

FIG. 40 is a diagram of a state of equivalence after completion of the initial copying;

FIG. 41 is a diagram of an REC session that is in a “Suspend” state; and

FIG. 42 is a diagram of process sequence for checking the state of the comparative example.

### DESCRIPTION OF EMBODIMENTS

As described previously, a storage apparatus directly transfers data through no host. However, it causes the host strictly monitors whether data in a group has consistency and a checking process therefore is imposed on the host because when the consistency of the data is not assured, the reliability of data processing is degraded.

Preferred embodiments of the present invention will be explained with reference to accompanying drawings.

### [a] First Embodiment

In each embodiment, a “storage system” is a system for storage that accumulates data and that includes recording media such as memories, hard disks or optical disks. A “volume” is a means of having recorded thereon data and is a unit of medium or recording area in a medium. A single medium may configure a plurality of volumes, or a plurality of media may configure a single volume. A “session” is a logical connection relation such as communication that is set to exchange data such as data transfer and, in this embodiment, includes a connection relation between a copying origin housing and a copying destination housing that is set for data copying.

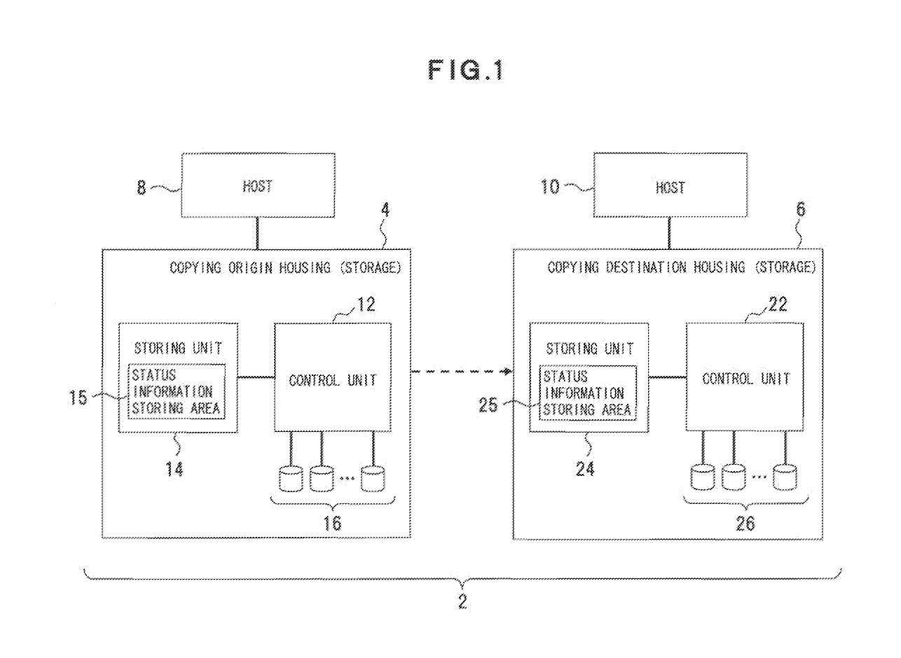

The first embodiment will be described with reference to FIG. 1. FIG. 1 is a diagram of an example of a storage system according to the first embodiment.

A storage system 2 depicted in FIG. 1 is an example of the storage system and the storage control method that are disclosed herein, and includes a copying origin housing 4 as a first storage apparatus and a copying destination housing 6 as a second storage apparatus. The first embodiment is a storage system that includes the copying origin housing and the copying destination housing, and is configured to, using the storages, group-manage copying sessions of a plurality of volumes having stored therein data dividing the data. In the group-management: a status information storing area is created in a storing unit in a storage triggered by grouping; a status of each group is stored in the status information storing area; and this storage is notified to a host or is able to be checked by the host.

The copying origin housing 4 is an example of a storage means and is a storage apparatus that has stored therein data of the copying origin. A first host 8 is connected as an external control apparatus to the copying origin housing 4. The host 8 is a means of instructing data writing etc., to the copying origin housing 4 and is configured by a host computer.

The copying destination housing 6 is an example of a storage means and is a storage apparatus that has stored therein data transferred from the copying origin. A second host 10 as an external control apparatus is connected to the copying destination housing 6. The host 10 is a control means that uses data accumulated in the copying destination housing 6, and is configured by a host computer similarly to the host 8.

The copying origin housing 4 is provided with a control unit 12, a storing unit 14 and a plurality of volumes 16. The control unit 12 is a means of grouping the plurality of volumes 16 that divide data and that each have stored therein a divided piece of data, and of causing the storing unit 14 to create a status information storing area 15 described later triggered by execution of each of various processes such as data writing or data management or, for example, grouping of copying sessions. That is, the control unit 12 is a means of managing the volumes 16 by group for each data, and also is an example of a creating unit of the status information storing area. The control unit 12 also constitutes a notifying unit notifying the host 8 of the status information.

The storing unit 14 is a means of having stored therein the status information for each group of sessions of copying data of the volumes 16 and, as the means of having stored therein the status information, creates, for example, the status information storing area 15. The status information storing area 15 is created triggered by the grouping of the copying sessions and is configured by, for example, a table.

As described above, the volumes 16 each are a means of having data recorded thereon and each are a unit of medium or recording area in the medium.

The copying destination housing 6 is provided with a control unit 22, a storing unit 24 and a plurality of volumes 26. The control unit 22 corresponds to the control unit 12, and is a means of grouping the plurality of volumes 26 that each have stored therein a divided piece of data, and of causing the storing unit 24 to create a status information storing area 25 described later triggered by execution of each of various processes such as data writing or data management or, for example, grouping of copying sessions. That is, the control unit 22 is a means of managing the volumes 26 by group for each data, and also is an example of the creating unit of the status information storing area. The control unit 22 also constitutes a notifying unit notifying the host 10 of the status information.

Similarly to the storing unit 14, the storing unit 24 is a means of having stored therein the status information for each group of data copying sessions and, as the means of having stored therein the status information, creates, for example, the status information storing area 25. The status information storing area 25 is created triggered by the grouping of the copying sessions and includes, for example, a table.

Similarly to the volumes 16, the volumes 26 each are a means of having data recorded thereon and each are a unit of medium or recording area in the medium, as described above.

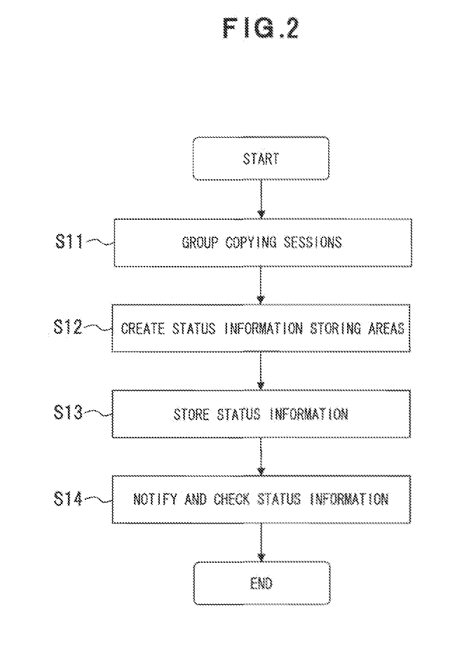

A constructing process of a consistency state of a group will be described with reference to FIG. 2. FIG. 2 is a flowchart of a process procedure of the constructing process of the consistency state of the group.

The process procedure is an example of the storage control method disclosed herein and is an example of a storage control program that is executed by a computer. That is, the process procedure includes a process of controlling a copying session of copying data from the copying origin housing 4 to the copying destination housing 6.

According to the process procedure, as depicted in FIG. 2, the copying sessions are grouped of the plurality of volumes 16 and 26 that have data stored therein dividing the data (S11).

Triggered by this grouping, the storing units 14 and 24 are caused to respectively create the status information storing areas 15 and 25 (S12). Each of the status information storing areas 15 and 25 has stored therein the status information of the copying sessions for each group (S13).

The pieces of status information stored in the status information storing areas 15 and 25 in the storages (the copying origin housing 4 and the copying destination housing 6) are notified to the hosts 8 and 10 in response to accesses from the hosts 8 and 10 and, thereby, are able to be checked from the hosts 8 and 10 (S14).

According to the above configuration: the copying sessions are grouped of the plurality of volumes that have the data stored therein dividing the data; triggered by the grouping, the storing units 14 and 24 in the storages are caused to create the status information storing areas 15 and 25; and the consistency of the data is managed for each group. In this case, the pieces of status information are stored in the storing units 14 and 24 for each group of the copying sessions. Therefore, the status information stored in the storing unit 14 can be checked from the host 8 and, similarly, the status information stored in the storing unit 24 can be checked from the host 10. The hosts 8 and 10 each can easily check the state of the data that has been processed for its consistency by the storage apparatuses.

Therefore, in the storage system 2 that is a system of group-managing the volumes, the storages monitor and manage the consistency of the data of the group and, therefore, complicated processes for the hosts 8 and 10 to construct and check the consistency of the data can be omitted. Therefore, the hosts 8 and 10 can be relieved from the load of checking the content of the data etc. Therefore, for example, after the data has suffered from a disaster, the suffering can easily be grasped by checking the consistency of the data. Therefore, for example, RTO (Recovery Time Objective) in a duty resuming process of the system can be simplified and the recovery work of the system can be expedited.

### [b] Second Embodiment

A second embodiment embodies the configuration described in the first embodiment, exemplifies the suffering of the data copying, and refers to the configuration, functions and the processing content of a storage system that contributes to the REC management to expedite the above RTO.

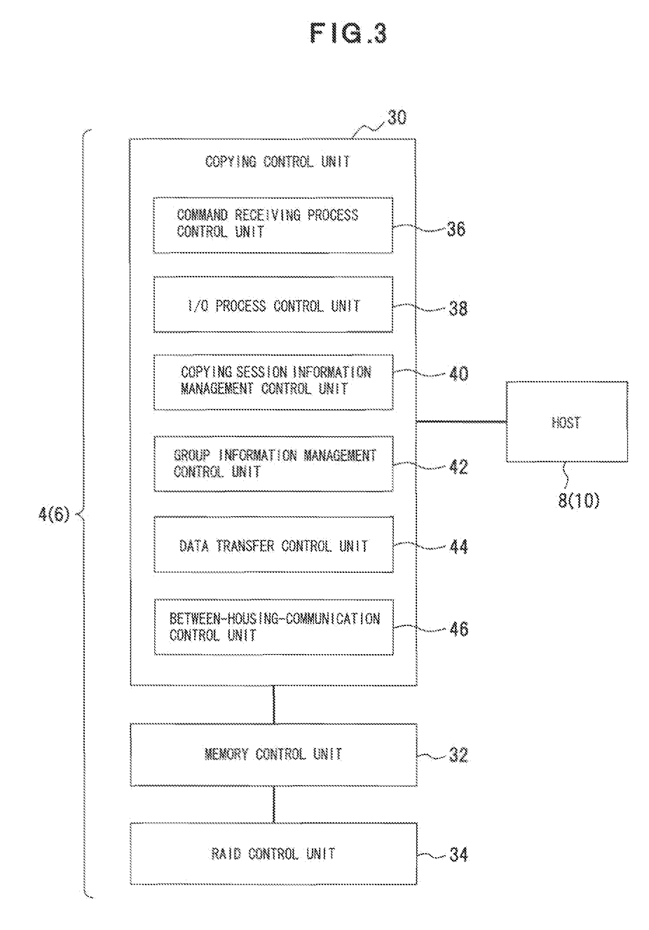

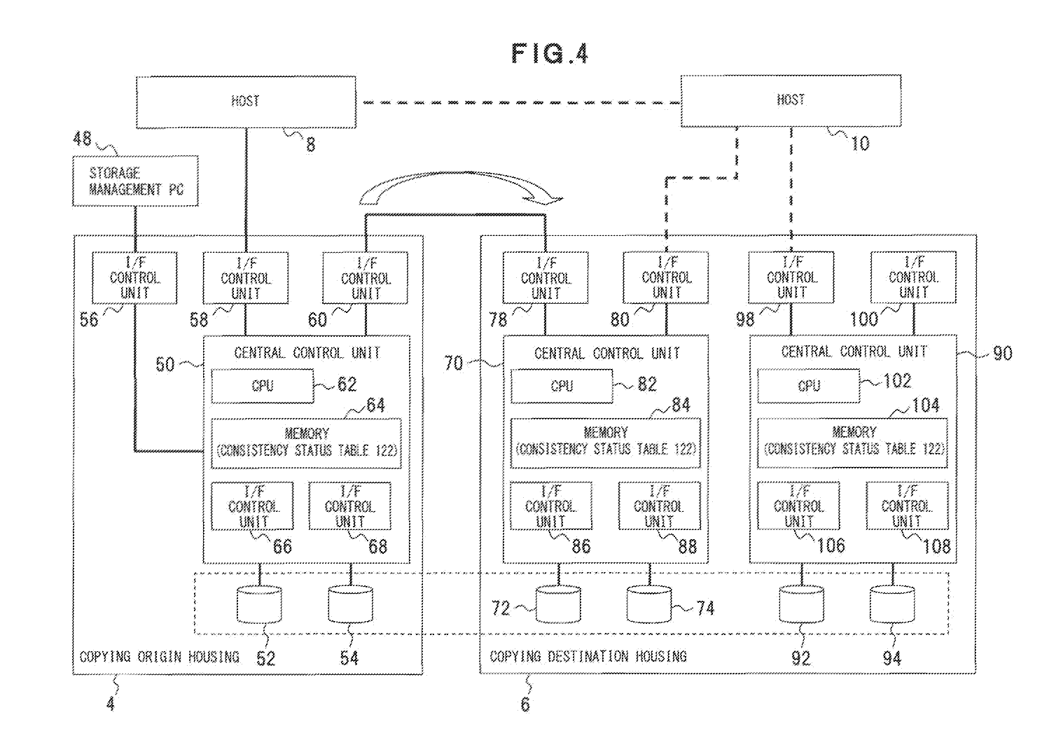

The second embodiment will be described with reference to FIGS. 3 and 4. FIG. 3 is a diagram of an exemplary configuration of functional units of the storage system. FIG. 4 is a diagram of an exemplary hardware configuration of the storage system.

The storages of FIG. 3 (the copying origin housing 4 and the copying destination housing 6) that configure the storage system 2 each include a copying control unit 30, a memory control unit 32, and a RAID control unit 34 to group-manage the copying sessions.

The copying control unit 30 corresponds to the above control unit 12 (22) and is a functional unit that executes management of a copying function (data backing up). In this case, the “copying” refers to the above remote-equivalent copying (REC) function.

The memory control unit 32 is a functional unit that executes management of a primary storage area of the storage. The RAID control unit 34 is a functional unit that executes RAID (Redundant Array of Inexpensive Disks) control and reading or writing (Read/Write) from/to a disk of the storage.

The copying control unit 30 includes a command receiving process control unit 36, an I/O (Input/Output) process control unit 38, a copying session information management control unit 40, a group information management control unit 42, a data transfer control unit 44 and a between-housing-communication control unit 46.

The command receiving process control unit 36 is a functional unit that executes control of commands of the above copying function.

The I/O process control unit 38 is a functional unit that executes control of writing and reading to/from areas of the copying function.

The copying session information management control unit 40 is a functional unit that executes management of the copying sessions, and executes processing of group information tables.

The group information management control unit 42 is a functional unit managing the status information that indicates the consistency of each group.

The data transfer control unit 44 is a functional unit that executes control of transferring data of the copying origin housing 4 to the copying destination housing 6.

The between-housing-communication control unit 46 is a functional unit that executes a communicating function executed when data is communicated between the copying origin housing 4 and the copying destination housing 6, and executes transfer of the group status.

As depicted in FIG. 4, the storage system 2 includes hardware that realizes the above functional units. The storage system 2 includes the copying origin housing 4 and the copying destination housing 6. The copying origin housing 4 is connected to the host 8 and the copying destination housing 6 is connected to the host 10. The copying origin housing 4 is installed with a storage management personal computer (PC) 48 as a storage managing apparatus. The hosts 8 and 10 each are configured by a host computer that is used by an operator.

The copying origin housing 4 configures a copying origin housing (on an operating side) that is a storage of user data. The copying destination housing 6 is a copying destination housing that is installed in a remote location and that is a storage to copy the user data.

The copying origin housing 4 includes a central control unit 50, disks 52 and 54, and I/F (Interface) control units 56, 58 and 60.

The central control unit 50 is hardware that realizes the above functional units (FIG. 3). An example of hardware is CM (Centralized Module). The central control unit 50 is also a control unit (controller) that executes management of resources such as control of memories of the disks 52 and 54, the I/F control units 56, 58 and 60, and a memory 64, and control of copying. The central control unit 50 is a notifying unit notifying the host 8 of the status information, and is an example of the storing area creating unit that causes the memory 64 to create the above status information storing area.

The disks 52 and 54 configure the above plurality of volumes 16 and are user disks. The I/F control unit 56 is a port that is connected to the storage management PC 48 and that is also a control unit of the port. The I/F control unit 58 is a connecting means of connecting to the host 8, and is a channel adapter (CA). An I/F control unit 60 is a remote connecting means of connecting to the copying destination housing 6 and is a remote adaptor (RA).

The central control unit 50 includes a CPU (Central Processing Unit) 62, the memory 64 and I/F control units 66 and 68.

The CPU 62 executes programs such as an OS (Operating System) stored in the memory 64, and controls the copying function.

The memory 64 is a recording medium that is set in the central control unit 50, is configured by, for example, a cache memory, and has stored therein user data, control data, etc.

In the memory 64, a consistency status table 122 is created as an example of the above status information storing area 15 and the status information of a group is stored and managed therein.

The I/F control unit 66 is an interface that is connected to the disk 52. The I/F control unit 68 is an interface that is connected to the disk 54.

The copying destination housing 6 includes: a first and a second central control units 70 and 90; disks 72, 74, 92 and 94; and I/F control units 78, 80, 98 and 100.

The central control unit 70 is hardware (CM) that realizes the above functional units (FIG. 3) and is a control unit (controller) that executes management of resources such as control of memories of the disks 72 and 74, the I/F control units 78 and 80, and a memory 84, and control of copying. The central control unit 70 is an example of the storing area creating unit that causes the memory 84 to create the above status information storing area.

The central control unit 90 is hardware (CM) that realizes the above functional units (FIG. 3), and is a control unit (controller) that executes management of resources such as control of memories of the disks 92 and 94, the I/F control units 98 and 100, and a memory 104, and control of copying. The central control units 70 and 90 are also units notifying the host 10 of the pieces of status information. The central control unit 90 is an example of the storing area creating unit that causes the memory 104 to create the above status information storing area.

The disks 72, 74, 92 and 94 configure the above plurality of volumes 26 and are user disks. The I/F control unit 78 is a remote connecting means of connecting to the copying origin housing 4 and is a remote adaptor (RA). The I/F control units 80 and 98 are means of connecting to the host 10 and are channel adaptors (CA).

The central control unit 70 includes a CPU 82, the memory 84 and I/F control units 86 and 88. The central control unit 90 includes a CPU 102, the memory 104 and I/F control units 106 and 108.

The CPU 82 executes programs such as an OS stored in the memory 84 and controls the copying function. The CPU 102 executes programs such as an OS stored in the memory 104 and controls the copying function.

The memory 84 is a recording medium that is set in the central control unit 70, is configured by, for example, a cache memory, and has stored therein user data, control data, etc. In the memory 84, the consistency status table 122 is created as an example of the above status information storing area 25 and the status information of a group is stored and managed therein. Simultaneously, the memory 104 is a recording medium that is set in the central control unit 90, is configured by, for example, a cache memory, and has stored therein user data, control data, etc. In the memory 104, the consistency status table 122 is also created as an example of the above status information storing area 25 and the status information of a group is stored and managed therein.

The I/F control unit 86 is an interface that is connected to the disk 72. The I/F control unit 88 is an interface that is connected to the disk 74. The I/F control unit 106 is an interface that is connected to the disk 92. The I/F control unit 108 is an interface that is connected to the disk 94.

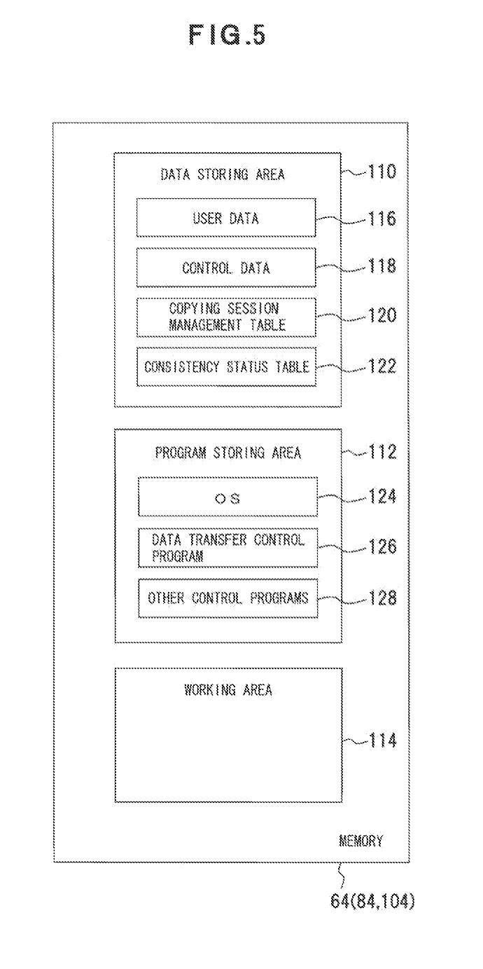

The memories 64, 84 and 104 will be described with reference to FIG. 5. FIG. 5 is a diagram of an exemplary configuration of each of the memories. In FIG. 5, the same parts as those of FIG. 4 are given the same reference numerals.

The memory 64 is configured by, for example, a cache memory and, as depicted in FIG. 5, a data storing area 110, a program storing area 112 and a working area 114 are set in the memory 64. The data storing area 110 has stored therein user data 116 and control data 118, and is formed thereon with a copying session management table 120 and the consistency status table 122. The copying session management table 120 has stored therein management information of copying sessions. The consistency status table 122 has stored therein the status information of a group. The program storing area 112 has stored therein an OS 124, a data transfer control program 126 and other control programs 128. The working area 114 is used for computing processes and control processes.

Each of the memories 84 and 104 may include the same configuration as that of the memory 64, and includes that configuration in this embodiment. Thus, the description thereof will be omitted.

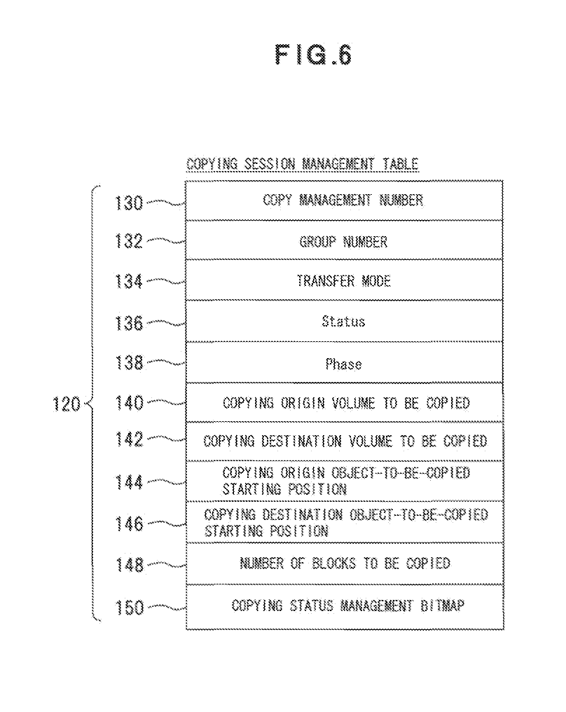

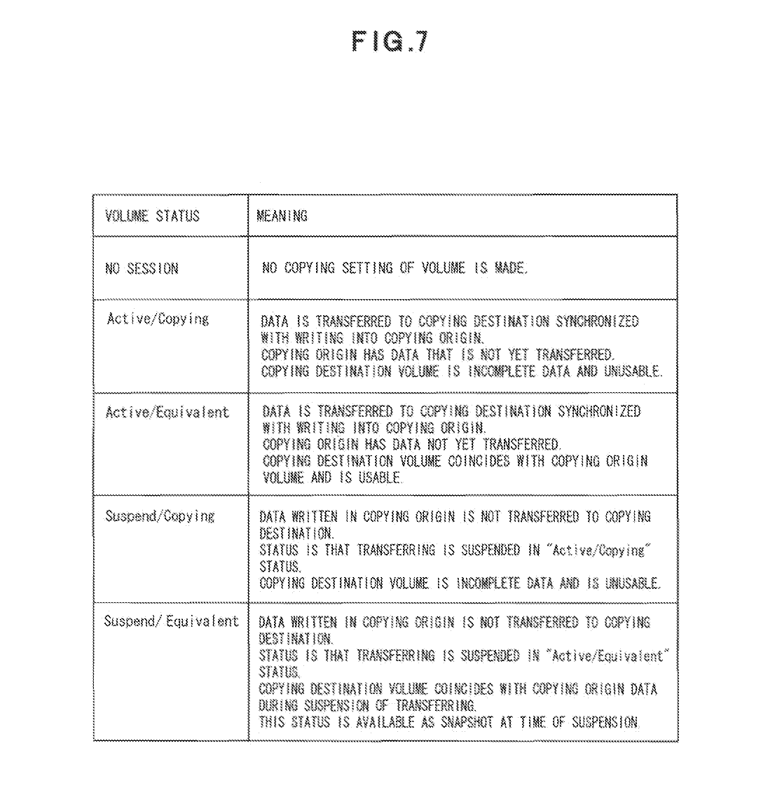

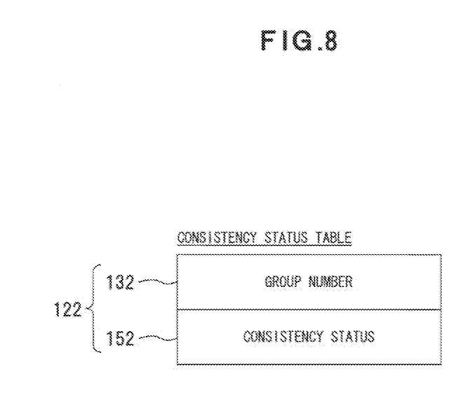

Each of the management tables will be described with reference to FIGS. 6, 7 and 8. FIG. 6 is a diagram of an example of a copying session management table. FIG. 7 is an explanatory diagram of volume statuses and their meanings. FIG. 8 is a diagram of an example of a consistency status table.

The copying session management table 120 has stored therein management information to manage copying data by group. The management information includes pieces of identification information such as the identification, the mode, the status, the phase and the volumes of a group. As depicted in FIG. 6, the copying session management table 120 has stored therein a copy management number 130, a group number 132, a transfer mode 134, a status 136 and a phase 138. The copying session management table 120 further has stored therein a copying origin volume to be copied 140 and a copying destination volume to be copied 142. The copying session management table 120 further has stored therein a copying origin object-to-be-copied starting position 144, a copying destination object-to-be-copied starting position 146, the number of blocks to be copied 148 and a copying status management bitmap (Bitmap) 150.

The copy management number 130 is a unique number given to each copying session. The group number 132 is an example of the identification information to identify a group.

The transfer mode 134 is information that indicates the type of copying, and the types of copying mode include a synchronized mode and a non-synchronized mode. The transfer mode 134 has stored therein either the synchronized mode or the non-synchronized mode.

The status 136 is information that indicates the status of a copying session. The type of status is any one of an initial status (Idle), an operating status (Active), a temporarily suspended status (Suspend) and an error status (Errsus).

The phase 138 indicates an operation of a copying session. The types of phase include “copying process non-operation (Nopair)”, “copying process in-operation (Copying)” and “equivalence status (Equivalent)”.

The volume statuses and their meanings are as depicted in FIG. 7 and “no session” represents that no copying setting of a volume is made. “Active/Copying” represents transferring of data to a copying destination synchronized with writing into the copying origin. The copying origin has data that is not yet transferred. The copying destination volume is incomplete data and unusable. “Active/Equivalent” represents transferring of data to the copying destination synchronized with writing into the copying origin. The copying origin has data not yet transferred. The copying destination volume coincides with the copying origin volume and is usable. “Suspend/Copying” represents no transferring of data written in the copying origin to the copying destination. This is the status where the transferring is suspended in the “Active/Copying” status, and the copying destination volume is incomplete data and is unusable. “Suspend/Equivalent” represents no transferring of data written in the copying origin to the copying destination. This is the status where the transferring is suspended in the “Active/Equivalent” status, and the copying destination volume coincides with the copying origin data during the suspension of the transferring. This status is available as a snapshot at the time of the suspension. The part having “Suspend” described therein is in a status that is either of “Suspend” (suspension designated by the host) and “Halt” (suspension due to an error caused by detection of line disconnection in a storage etc.) and, in the embodiment, these two statuses are collectively described as “Suspend”.

The copying origin volume to be copied 140 is identification information of the volume of the copying origin that is to be copied and is, for example, a transfer origin logic unit number (copying origin LUN).

The copying destination volume to be copied 142 is identification information of the volume of the copying destination that is to be copied and is, for example, a transfer destination logic unit number (copying destination LUN).

The copying origin object-to-be-copied starting position 144 is information that identifies the starting position in the object to be copied of the copying origin and is, for example, a copying starting address in a transfer origin logic unit (copying origin object-to-be-copied starting LBA).

The copying destination object-to-be-copied starting position 146 is information that identifies the starting position in the object to be copied of the copying destination and is, for example, a copying starting address in a transfer destination logic unit (copying destination object-to-be-copied starting LBA).

The number of blocks to be copied 148 represents the amount of the copy to be transferred of the object to be copied. The copying status management bitmap 150 is bitmap information that indicates the copying status. Because the copying status is managed using the bitmap, the copying status management bitmap 150 is information that indicates the copying status.

The consistency status table 122 is created based on the designation of a group number by starting of the copying (Start of REC). The consistency status tables 122 of the number equal to that of groups are retained in the data storing area 110 of each of the memories 64, 84 and 104 in the central control units 50, 70 and 90. The consistency status table 122 has stored therein information that indicates the consistency of data for each group and, in the embodiment, as depicted in FIG. 8, has stored therein the group number 132 and a consistency status 152. The group number 132 corresponds to the group number 132 of the copying session management table 120. The consistency status table 122 is correlated with the copying session management table 120 by the group number 132. The consistency status 152 is status information that indicates whether the consistency is present.

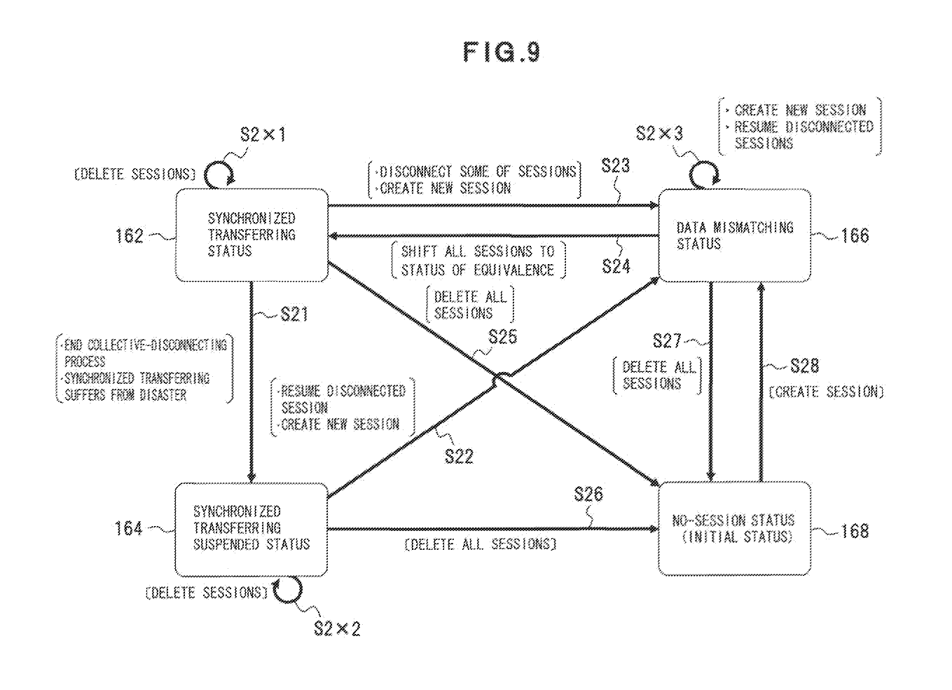

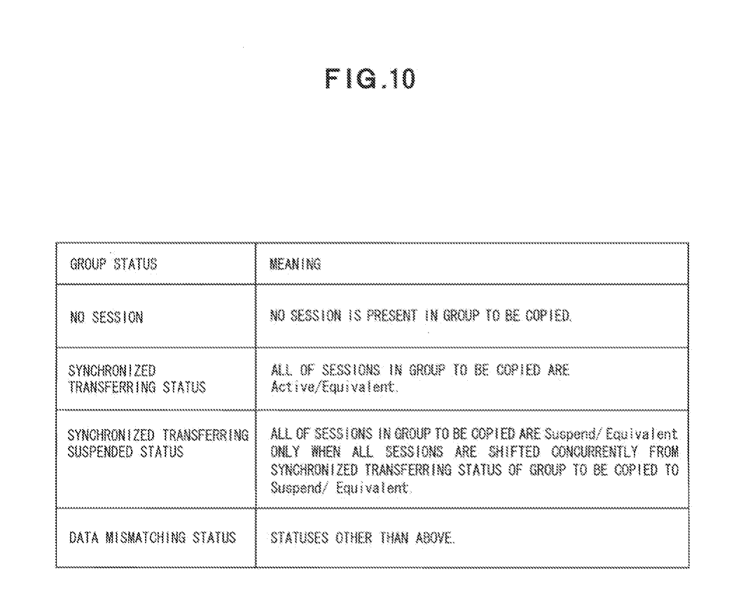

Consistency management of a copying session group will be described with reference to FIGS. 9 and 10. FIG. 9 is a diagram of a status transition of the consistency management of a copying session group. FIG. 10 is a diagram of group statuses and their meanings.

A copying session executed when a plurality of synchronized backups are in operation is managed using the copying session management table 120. As above, the copying session management table 120 has stored therein pieces of the management information such as a management number that represents a copying session, the volume to be copied, the size of the volume, the starting position and the group number. The status of consistency of each copying group is managed using the consistency status table 122.

For example, the consistency status table 122 is newly prepared as a structure for each copying group and the status representing the consistency is created in the consistency status table 122. As depicted in FIG. 9, four statuses of a synchronized transferring status 162, a synchronized transferring suspended status 164, a data mismatching status 166 and a no-session status 168 are defined as the statuses used as the determination criteria of the consistency of the group, and each of these statuses is separately monitored and the status is changed in response to the change of the session status. The “synchronized transferring status 162” refers to the status where all of the synchronized copying sessions that constitute a group are equivalent to each other. The “synchronized transferring suspended status 164” refers to the status where all of the synchronized copying sessions that constitute the group are disconnected when a collectively-disconnecting process is executed for the group in the synchronized transferring status 162. The no-session status 168 refers to the status where no synchronized copying session is present at all in the group. The data mismatching status 166 refers to any of other statuses than the above. When the status is either of the synchronized transferring status 162 or the synchronized transferring suspended status 164, it is determined that the data has its consistency. In other statuses, that is, in the data mismatching status 166 and the no-session status 168, it is determined that the data has no consistency. The group statuses and their meanings are as depicted in FIG. 10.

FIG. 9 depicts which status the status of the consistency of a group of copying sessions is changed to when an event has occurred.

When the collective-disconnecting process comes to an end from the synchronized transferring status 162 or when the synchronized transferring suffers from a disaster, the status is shifted to the synchronized transferring suspended status 164 (S21). Even when some of the sessions in the group are deleted from the synchronized transferring status 162, the status still is the synchronized transferring status 162 (S2X1).

When the session that is disconnected from the synchronized transferring suspended status 164 is resumed or when a new session is created, the status is shifted to the data mismatching status 166 (S22). When some of the sessions are disconnected from the synchronized transferring status 162 or when a new session is created, the status is shifted to the data mismatching status 166 (S23). Even when some of the sessions in the group are deleted from the synchronized transferring suspended status 164, the status is still the synchronized transferring suspended status 164 (S2X2).

When all the sessions are shifted from the data mismatching status 166 to the status of equivalence, the status is shifted to the synchronized transferring status 162 (S24). In the data mismatching status 166, when a new session is created or when the disconnected sessions in the group are resumed, the status still is the data mismatching status 166 (S2X3).

When all the sessions are deleted from the synchronized transferring status 162, the synchronized transferring suspended status 164 or the data mismatching status 166, the status is shifted to the no-session status 168 (S25 to S27), that is, to the initial status.

When a session is created from the no-session status 168, the status is shifted to the data mismatching status 166 (S28).

A changing process of the status that represents the consistency of the group is executed by the CPUs 62, 82 and 102 of the central control units 50, 70 and 90. The trigger of this execution is as follows.

(a) The case of creation, deletion, disconnection or resuming of a command to synchronized copying session that constitutes a group.

(b) The case where all the sessions of the synchronized copying sessions that constitute the group are equivalent to each other.

(c) The case where the collectively-disconnecting process is executed of the synchronized copying sessions that constitute a group.

The above synchronized transferring status 162, the synchronized transferring suspended status 164, the data mismatching status 166 and the no-session status 168 are set as the conditions for determination (determination criteria) of the status representing the consistency of a group. Therefore, when the status of a copying group is the synchronized transferring status 162 or the synchronized transferring suspended status 164, the data has consistency and, in other cases, the data has no consistency.

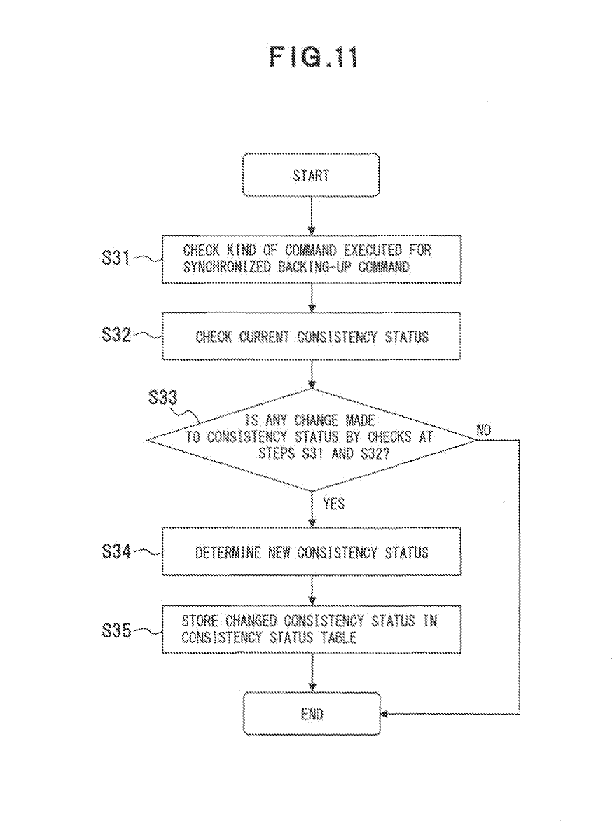

The status changing process will be described with reference to FIG. 11. FIG. 11 is a flowchart of a process procedure of the status changing process.

This process procedure is an example of the storage control method disclosed herein, and is a process procedure of changing the status of the consistency.

Changing to the above synchronized transferring suspended status 164 is executed based on the conditions for changing the consistency status. As far as a collective disconnection command process to the group or a collective stopping process of backing up in the group due to suffering from a disaster is not executed, the status is not shifted to the synchronized transferring suspended status 164. Therefore, even when each synchronized backing-up session that constitutes a group is disconnected at its own timing, the consistency status is the data mismatching status 166. Thereby, the consistency of the data is assured when a copying origin site suffers from a disaster and the synchronized backing up is disconnected.

According to the process procedure, as depicted in FIG. 11, when the consistency status changing process is started, the kind of command executed for a synchronized backing-up command is checked as a checking process (S31) and the current consistency status is checked (S32). By these checks at steps S31 and S32, it is checked whether any change is made to the consistency status (S33).

When it is determined that a change is made to the consistency status (YES of S33), a new consistency status is determined (S34), the consistency status changed is stored in the consistency status table 122 (S35) and the consistency status changing process comes to an end.

When it is determined that no change is made to the consistency status (NO of S33), the consistency status changing process comes to an end.

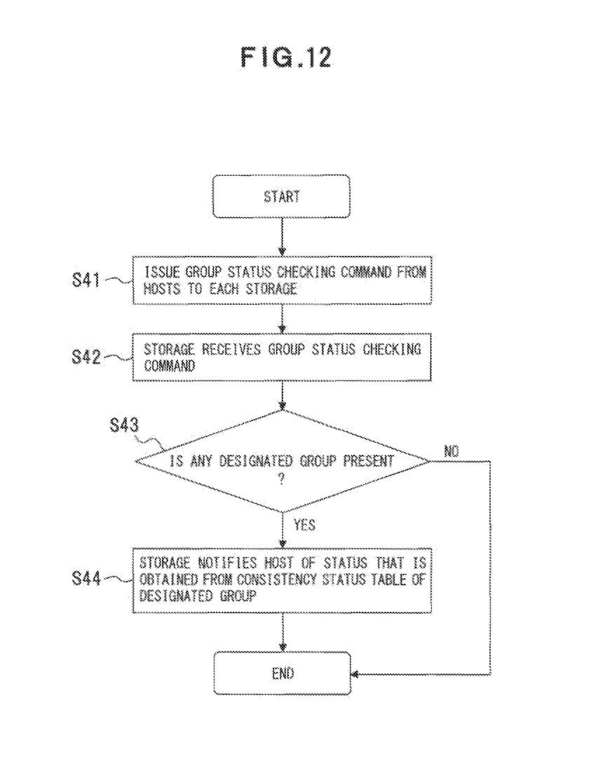

A status checking process will be described with reference to FIG. 12. FIG. 12 is a flowchart of a process procedure of the status checking process.

The process procedure is an example of the storage control method disclosed herein, is a process procedure of the status checking process, and is an obtaining process of the status of the consistency of a group of copying sessions executed when a plurality of synchronized backups are in operation.

The status of the consistency of a group can be obtained by issuing a command from the hosts 8 and 10 to storages (the copying origin housing 4 and the copying destination housing 6). Therefore, a group status checking command is newly created. This command is issued from a host to a backing-up origin storage or a backing-up destination storage, and the consistency status of each group stored in the data storing area 110 is obtained and is notified to the hosts 8 and 10.

According to this process procedure, when the consistency status checking process is started as the status checking process, a group status checking command is issued from the hosts 8 and 10 to each storage (S41). The storage receives the group status checking command (S42). Thereby, it is determined whether any designated group is present (S43). When it is determined that a designated group is present (YES of S43), the storage notifies the host of the status that is obtained from the consistency status table 122 of the designated group (S44) and the consistency status checking process comes to an end.

When it is determined that no designated group is present (NO of S43), the consistency status checking process comes to an end.

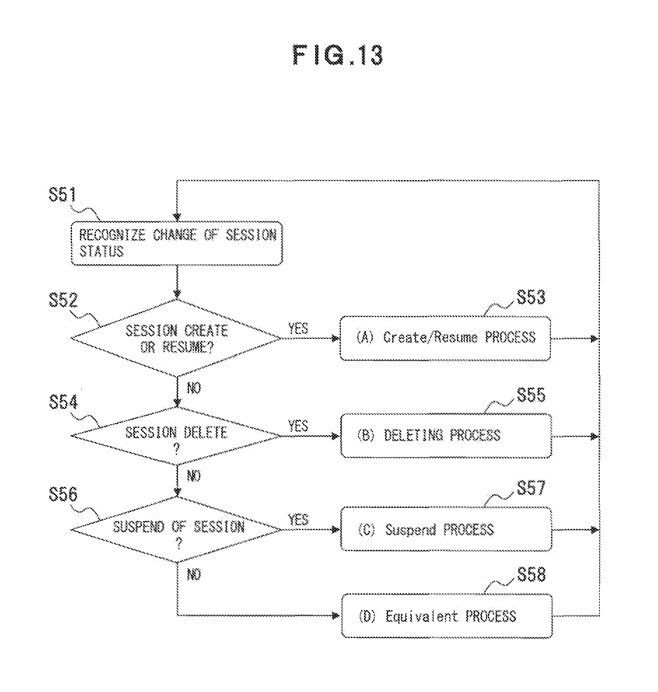

Changing of the group status will be described with reference to FIG. 13. FIG. 13 is a flowchart of a process procedure of changing the group status.

The changing of the group status is an example of the storage control method disclosed herein and is executed by cyclic processing of the processes.

According to the process procedure, the change of the session status is recognized (S51). When the change of the session status is recognized, it is checked whether the status is Session Create or Resume (S52). When it is confirmed that the status is Session Create or Resume (YES of S52), (A) Session Create/Resume process is executed (S53) and the procedure returns to step S51.

When it is confirmed that the status is not Session Create or Resume (NO of S52), it is checked whether the status is Session Delete (S54). When it is confirmed that the status is Session Delete (YES of S54), (B) deleting process is executed (S55) and the procedure returns to step S51.

When it is confirmed that the status is not Session Delete (NO of S54), it is checked whether the status is Suspend of the session (S56). When it is confirmed that the status is Suspend of the session (YES of S56), (C) Suspend process is executed (S57) and the procedure returns to step S51.

When it is confirmed that the status is not Suspend of the session (NO of S56), (D) Equivalent process is executed (S58) and the procedure returns to step S51.

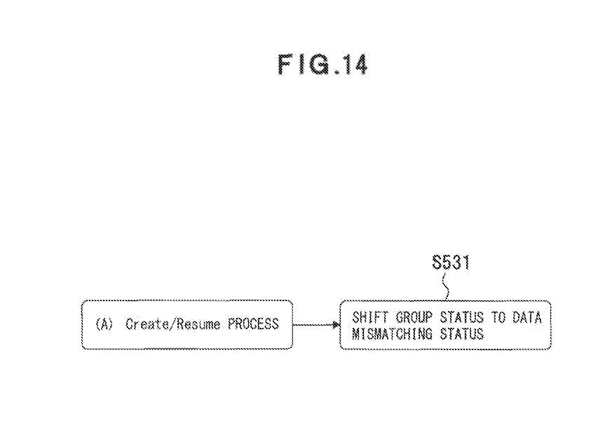

(A) Session Create/Resume will be described with reference to FIG. 14. FIG. 14 is a flowchart of a process procedure for changing the group status in (A) Session Create/Resume.

According to the process procedure, when the Session Create or Resume is executed, the group status is shifted to the data mismatching status (S531) and the procedure returns to the above step S51 (FIG. 13).

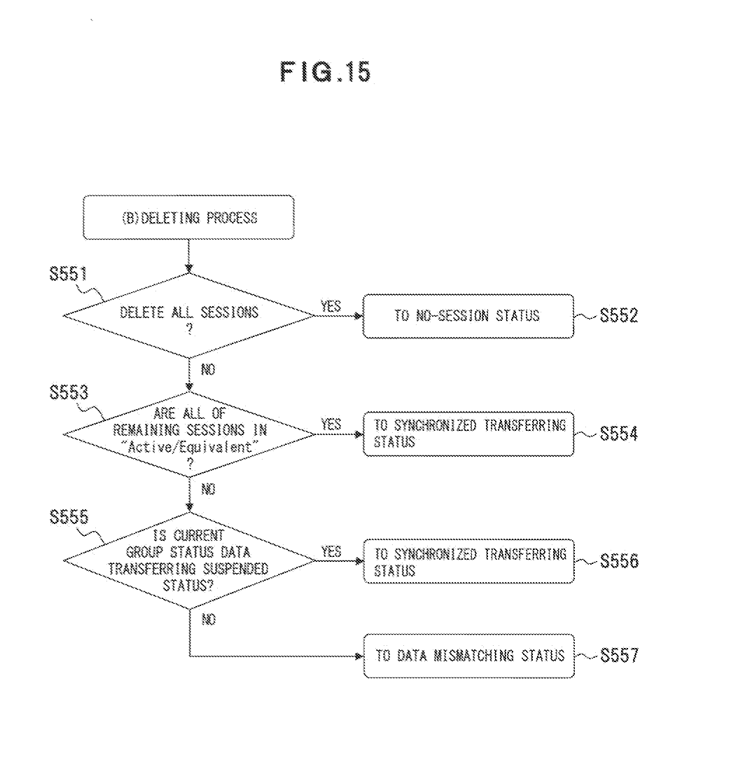

(B) deleting process will be described with reference to FIG. 15. FIG. 15 is a flowchart of a process procedure for changing the group status during (B) deleting process.

According to the process procedure, when execution of (B) deleting process is started, it is checked whether all the sessions are deleted (S551). When it is confirmed that all the sessions are deleted (YES of S551), the status is shifted to the no-session status (S552).

When it is confirmed that not all the sessions are deleted (NO of S551), it is checked that whether all of the remaining sessions are in “Active/Equivalent” (S553). When it is confirmed that all of the remaining sessions are in “Active/Equivalent” (YES of S553), the status is shifted to the synchronized transferring status (S554).

When it is confirmed that all of the remaining sessions are not in “Active/Equivalent” (NO of S553), it is checked that the current group status is the data transferring suspended status (S555). When it is confirmed that the current group status is the data transferring suspended status (YES of S555), the status is shifted to the synchronized transferring status (S556).

When it is confirmed that the current group status is not the data transferring suspended status (NO of S555), the status is shifted to the data mismatching status (S557).

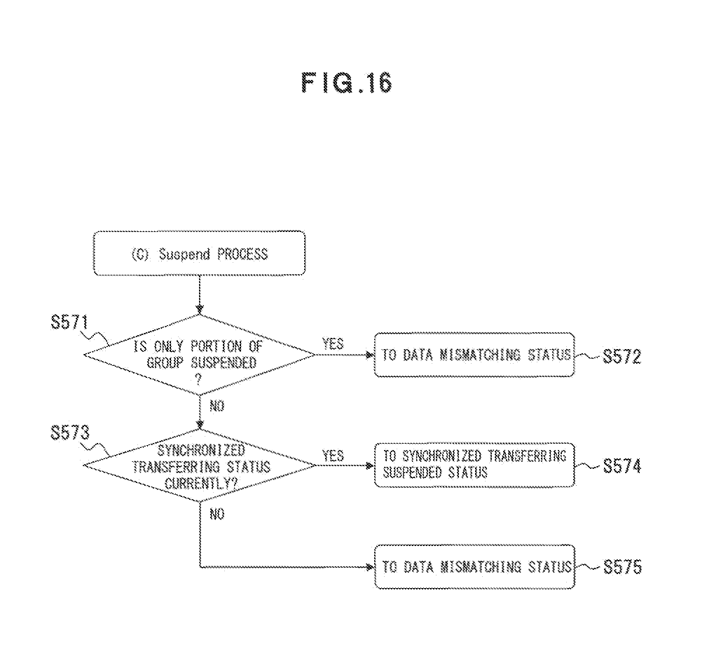

(C) Suspend process will be described with reference to FIG. 16. FIG. 16 is a flowchart of a process procedure of changing the group status during the Session Suspend process.

According to the process procedure, when execution of (C) Suspend process is started, it is checked whether the Suspend process is executed for only a portion of the group (S571). When it is confirmed that the Suspend process is executed for only the portion of the group (YES of S571), the status is shifted to the data mismatching status (S572).

When it is confirmed that the Suspend process is not executed for only the portion of the group (NO of S571), it is checked whether the status currently is the synchronized transferring status (S573). When it is confirmed that the status currently is the synchronized transferring status (YES of S573), the status is shifted to the synchronized transferring suspended status (S574). When it is confirmed that the status currently is not the synchronized transferring status (NO of S573), the status is shifted to the data mismatching status (S575).

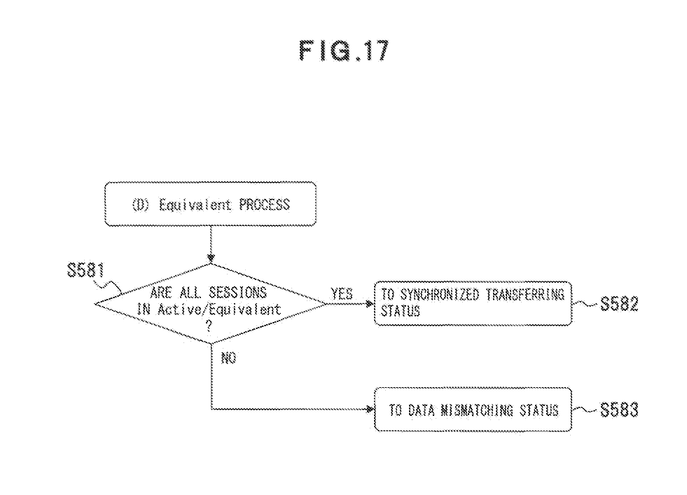

(D) Equivalent process will be described with reference to FIG. 17. FIG. 17 is a flowchart of a process procedure of changing the group status in Session Equivalent (completion of initial copying).

According to the process procedure, when execution of (D) Equivalent process is started, it is checked whether all the sessions are in Active/Equivalent (S581). When it is confirmed that all the sessions are in Active/Equivalent (YES of S581), the status is shifted to the synchronized transferring status (S582). When it is confirmed that all the sessions are not in Active/Equivalent (NO of S581), the status is shifted to the data mismatching status (S583).

As above, the status of the consistency of the data is determined and is assured. As to the consistency of the data, in the remote copying of the storage, to assure the “updating sequence from the host to the copying origin” and the “updating sequence from the copying origin to the copying destination” is regarded as equivalent to assuring of the consistency of the data at the copying destination. According to the storage system and the storage control method disclosed herein, when the matching status of the group is the synchronized transferring status 162, transferring to the copying destination is executed synchronized with the writing into the copying origin. Therefore, the sequence is assured. For the synchronized transferring suspended status 164, transferring of each of all the volumes in the group is concurrently suspended in the status where the sequence is assured and, therefore, the sequence is also assured in this case.

This sequence assurance causes the consistency of the data to be assured. The system has a function of recovering a file system or a database as a normal one by writing the file system or the database into a log before updating the data table even when a fault has occurred during the processing.

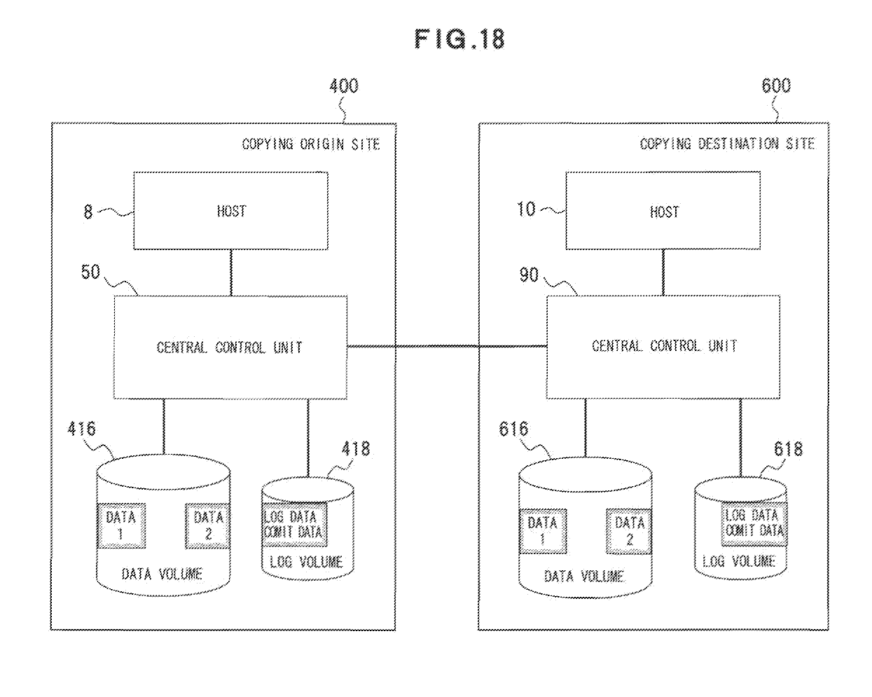

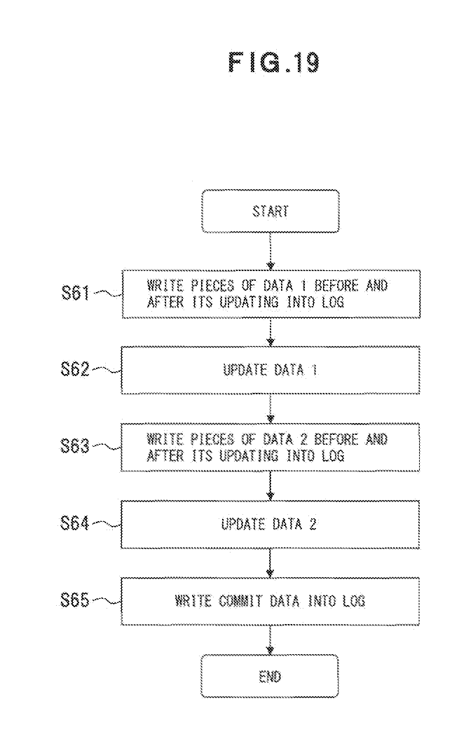

The sequence assurance will be described with reference to FIGS. 18 and 19. FIG. 18 is a diagram of an example of a log processing system between a copying origin site and a copying destination site. FIG. 19 is a flowchart of an example of a process procedure of a log recording process. In FIG. 18, the same parts as those of FIG. 4 are given the same reference numerals.

As depicted in FIG. 18, the log processing system has a copying origin site 400 and a copying destination site 600 present therein. The copying origin site 400 is provided with the host 8 and the central control unit 50 described above. The central control unit 50 includes a data volume 416 and a log volume 418. The copying destination site 600 is provided with the host 10 and the central control unit 90 described above. The central control unit 90 includes a data volume 616 and a log volume 618.

According to a process procedure of the data copying between the copying origin site 400 and the copying destination site 600, as depicted in FIG. 19, pieces of data 1 before and after its updating are written into a log (S61) and the data 1 is updated (S62). Pieces of data 2 before and after its updating are written into a log (S63) and the data 2 is updated (S64). Commit data is written into a log (S65).

In the log process, the pieces of data 1 and 2 are pieces of data to be concurrently updated. For example, the data 1 is data of a bank account debiting origin and the data 2 is data of a transfer destination. When the host suspends its operation due to an error during the process at step S63, a recovering process is operated after the host restarts. In the recovering process: a log is read; the commit data is retrieved; the pieces of data 1 and 2 that are not yet committed are recovered as the pieces of data before their updating. The host does not execute the writing at step S65 as far as a writing completion response at step S64 is not issued.

When the sequence is not assured in the remote copying, the status may be present where the processes at steps S61 to S65 have been completed on the copying origin site while only the commit data of each of the data 1 and data 5 is transferred and the data 2 is not transferred. In this state, even when the recovering process is started on the copying destination site, the mismatching state of the data 1 and 2 is not solved due to the presence of the commit data at step S65. Due to this, the copying destination site is not used as a database.

The data table and the log are usually stored separately from each other in different volumes and, therefore, the sequence (=consistency) of data between the volumes is preferably assured. According to the storage system and the storage control method disclosed herein, not limiting to the disks 52, 54, 72, 74, 92 and 94 (FIG. 4), the data volumes 416 and 616 and the log volumes 418 and 618 are grouped and it is assured that the consistency as the group is maintained.

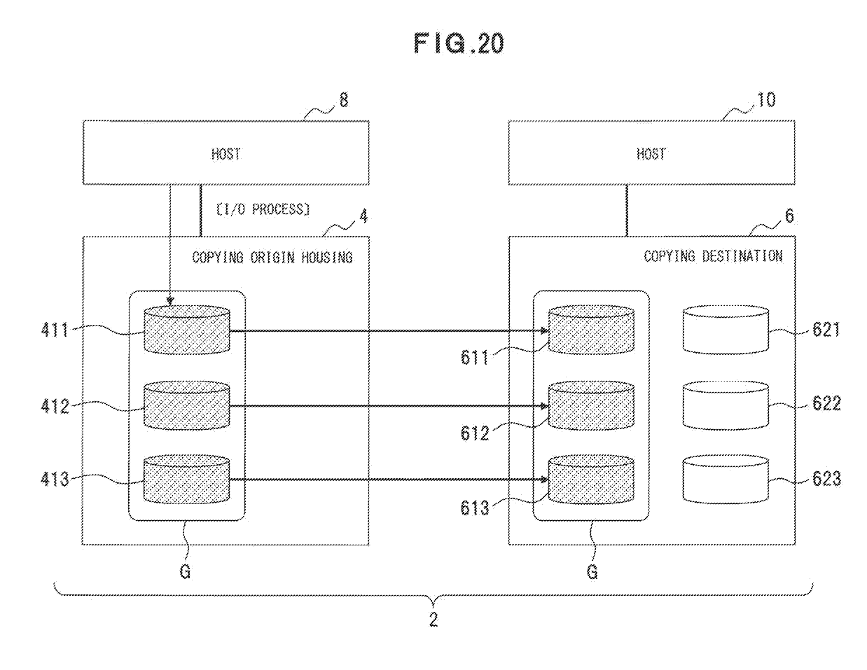

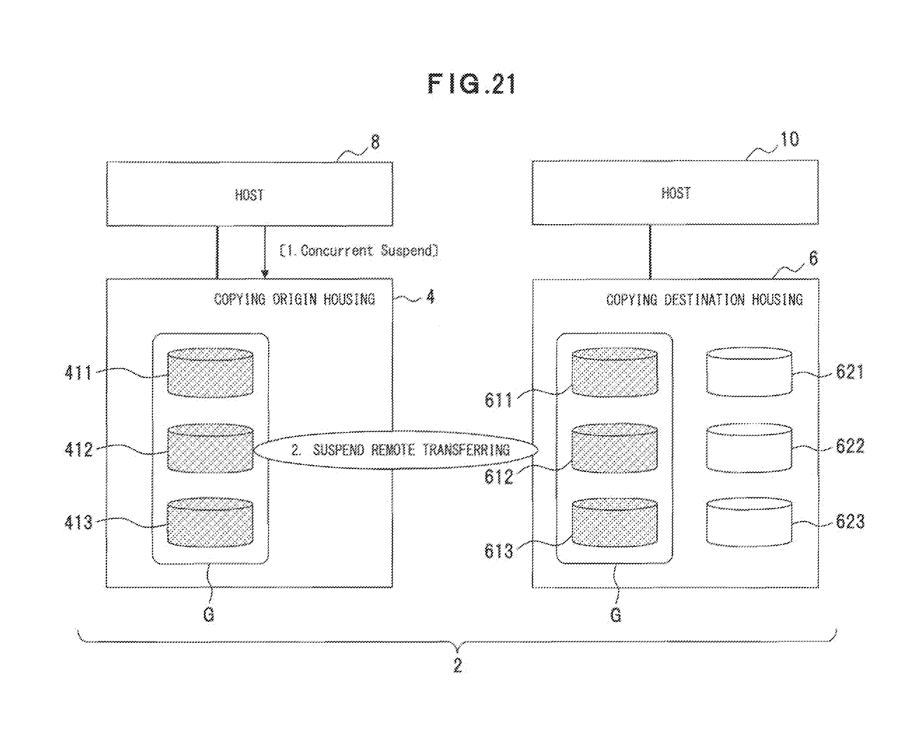

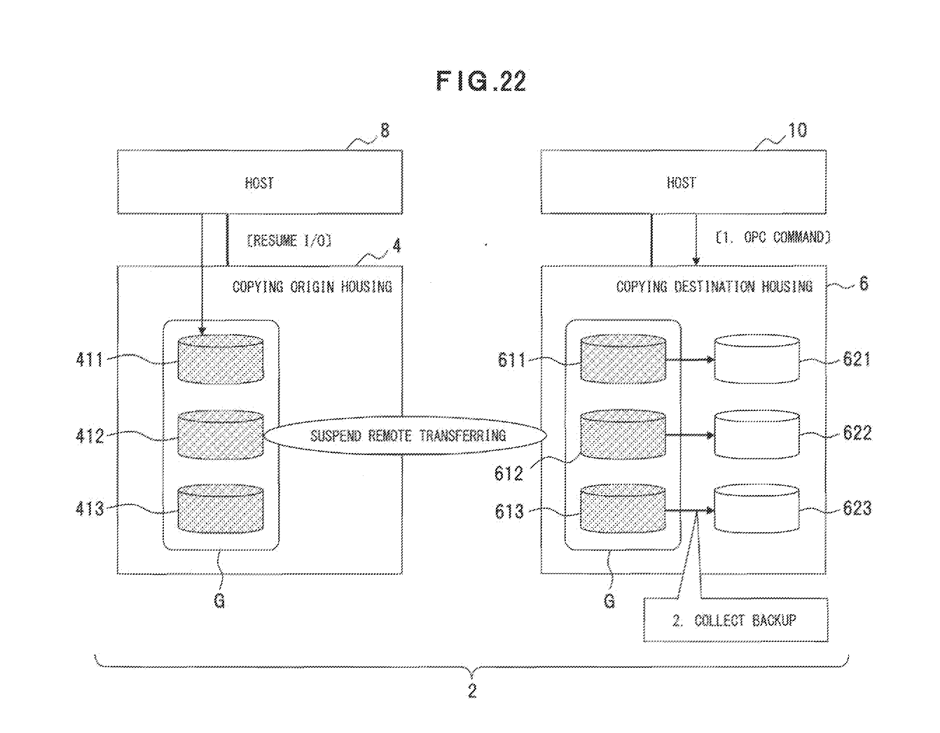

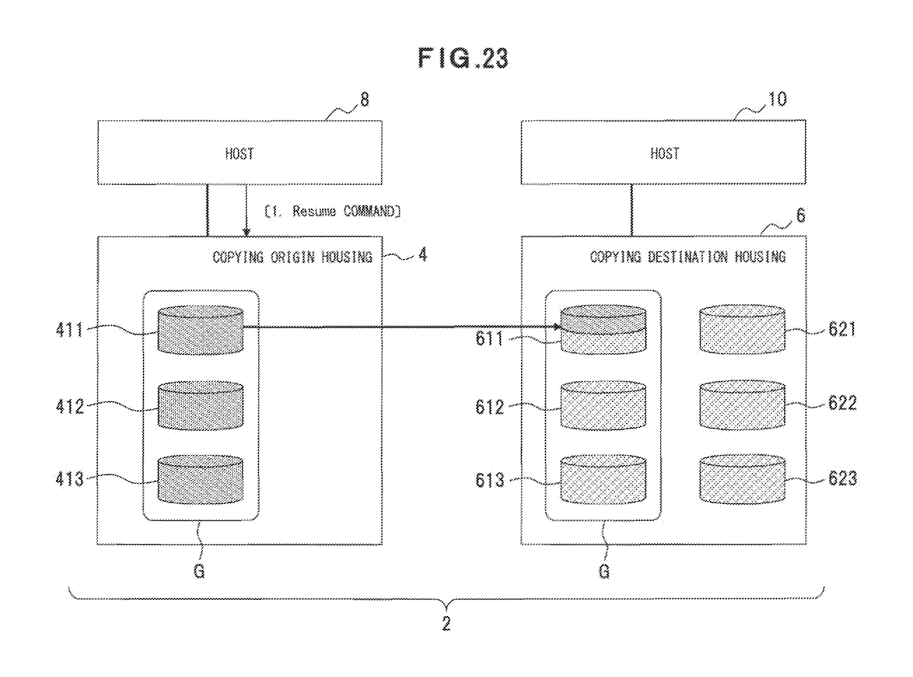

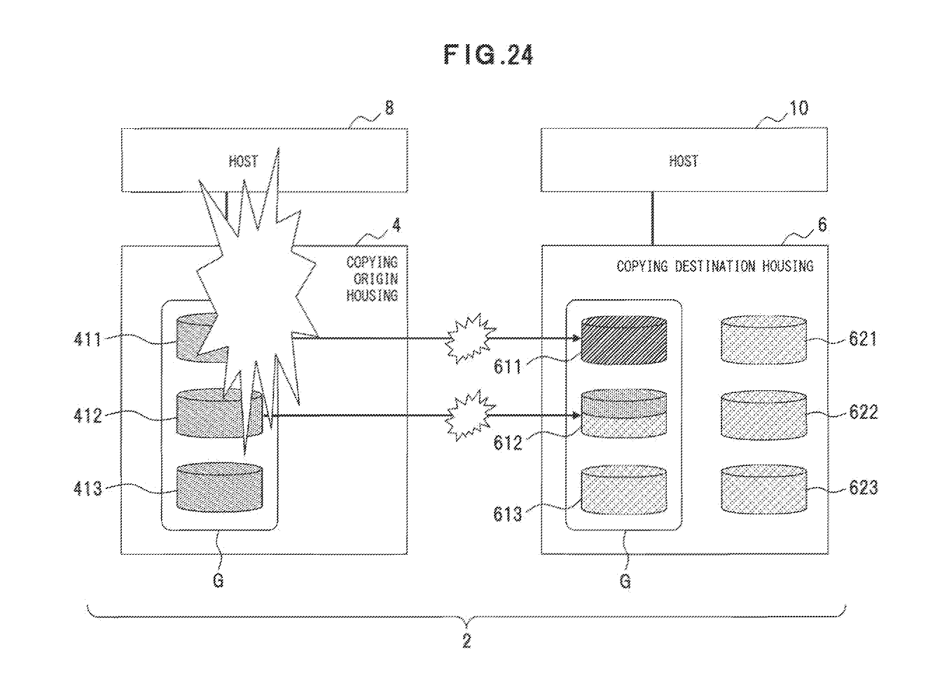

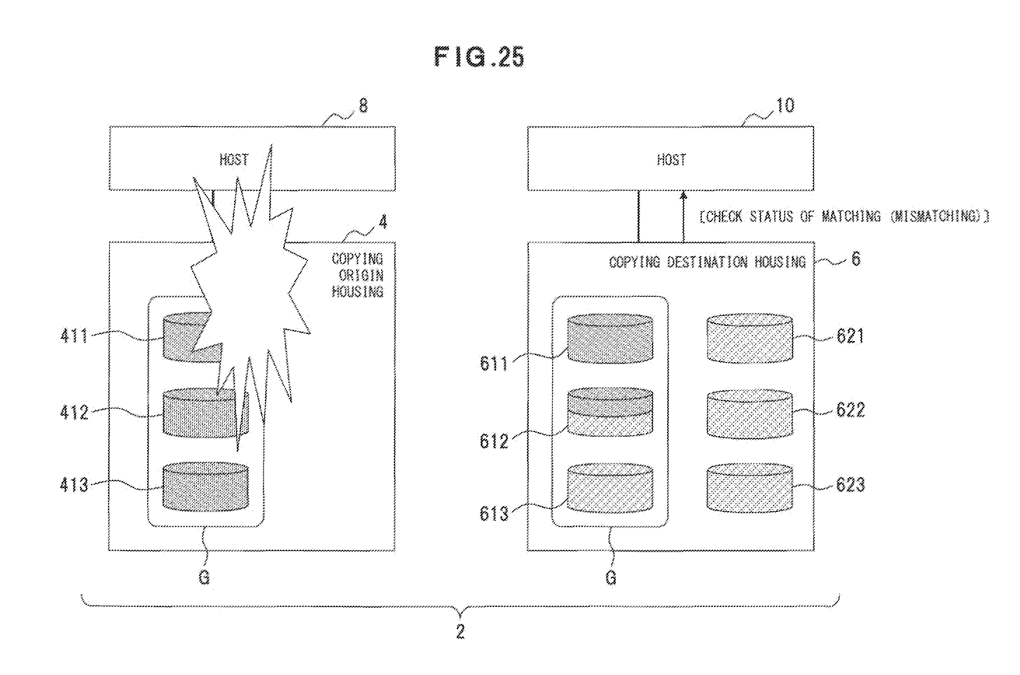

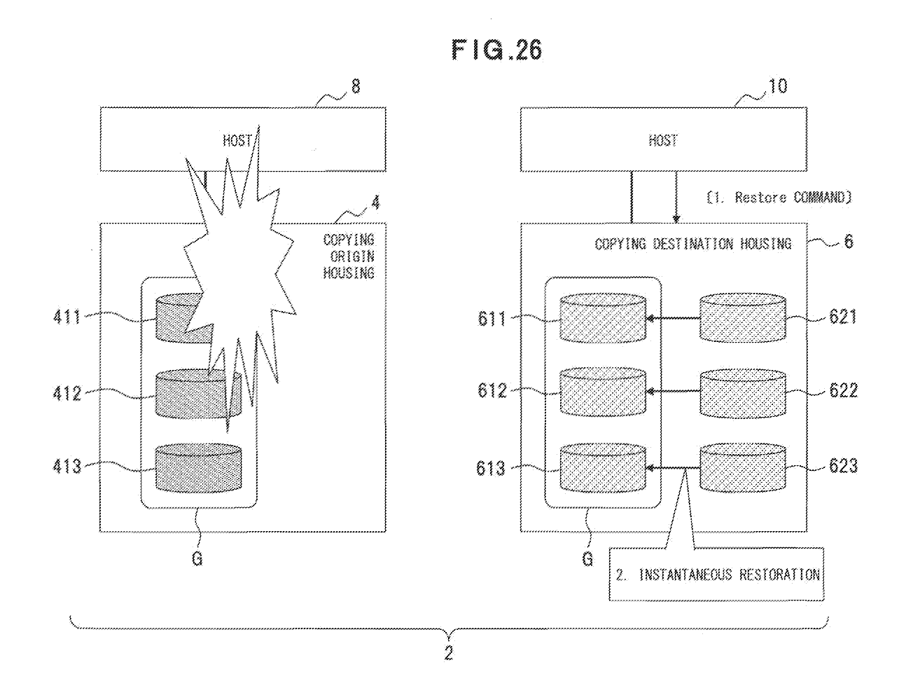

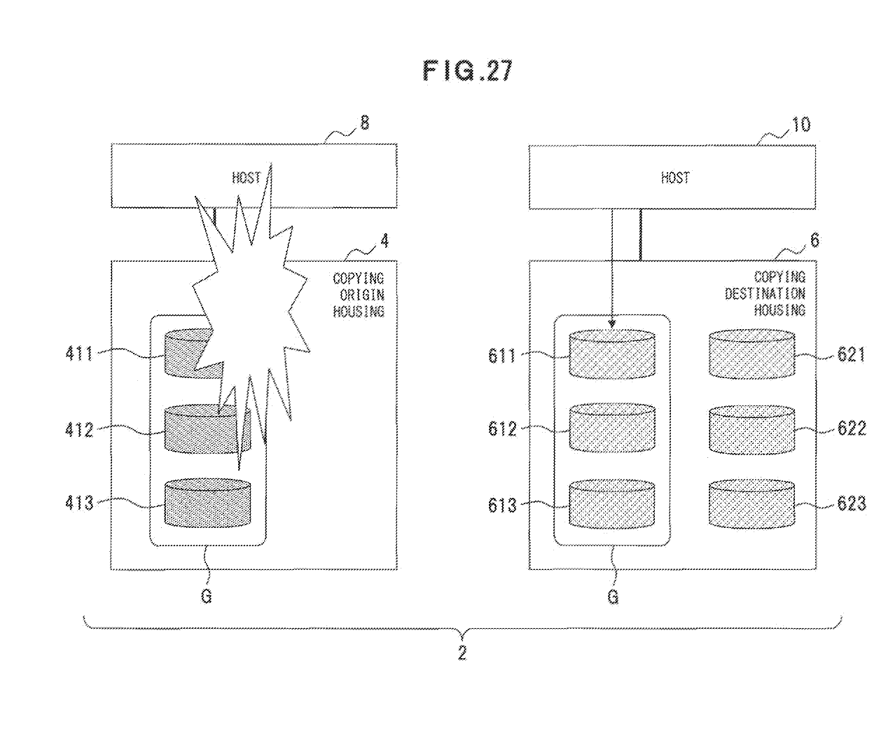

A recovering process procedure executed when the data has no consistency will be described with reference to FIGS. 20 to 27. FIG. 20 is a diagram of the synchronized transferring status. FIG. 21 is a diagram of the synchronized transferring suspended status. FIG. 22 is a diagram of collection of backup data. FIG. 23 is a diagram of the data mismatching status. FIG. 24 is a diagram of the data mismatching status at the time when a copying origin housing suffers from a disaster. FIG. 25 is a diagram of the data mismatching status. FIG. 26 is a diagram of a no-session status. FIG. 27 is a diagram of the no-session status as a result of resuming of a duty by the copying destination housing. In FIGS. 20 to 27, the same parts as those of FIG. 4 are given the same reference numerals.

The storage system 2 that configures the remote copying system suspends the transferring of the remote copy at specific timings and collects a backup of the data that is matched in the copying destination housing. In the case where the copying origin housing suffers from a disaster, when it is determined that the copying destination volume is not matched, the recovery can be executed using a backup that is of the one-generation pervious generation.

In the storage system 2, copying origin volumes 411 to 413 constitute one copying group G in the copying origin housing 4. Corresponding to this, copying destination volumes 611 to 613 and backup volumes 621 to 623 each constitute one copying group G in the copying destination housing 6.

During the ordinary operation (the synchronized transferring status), as depicted in FIG. 20, when the host 8 executes an I/O process, data is transferred from the copying origin volumes 411 to 413 in the copying origin housing 4 to the copying destination volumes 611 to 613 in the copying destination housing 6, and is copied.

To obtain a backup, in issuing a “Concurrent Suspend” command (the synchronized transferring suspended status), as depicted in FIG. 21, when the “Concurrent Suspend” command is issued from the host 8, the remote transferring is suspended, that is, the copying is suspended.

In collecting the backup (the synchronized transferring suspended status) in the copying destination housing 6, as depicted in FIG. 22: I/O resuming is executed by the hosts 8 and 10; an OPC command is issued from the host 10 to the copying destination housing 6; and the collection of the backup is executed in the copying destination housing 6. That is, the data is collected from the copying destination volumes 611 to 613 to the backup volumes 621 to 623.

When the copying is sequentially resumed (the data mismatching status), as depicted in FIG. 23, a “Resume” command is issued from the host 8 to the copying origin housing 4.

As depicted in FIG. 24, when the copying origin housing 4 suffers from a disaster before synchronization is established, the status becomes the data mismatching status.

When the copying origin housing 4 suffers from a disaster, as depicted in FIG. 25, the status of the matching is checked by the copying destination housing 6 and the status of the matching is recognized as mismatching. That is, the status is the data mismatching status.

When the copying origin housing 4 suffers from a disaster, as depicted in FIG. 26, a restore command is issued from the host 10 to the copying destination housing 6 and the copying destination housing 6 executes instantaneous restoration.

In this case, after the remote copying session is deleted, the copying destination housing 6 executes restoration from the backup volumes 621 to 623. The status is the no-session status.

When the copying origin housing 4 suffers from a disaster, as depicted in FIG. 27, the duty is resumed by the host 10 and the copying destination housing 6. In this case, the status is no-session status.

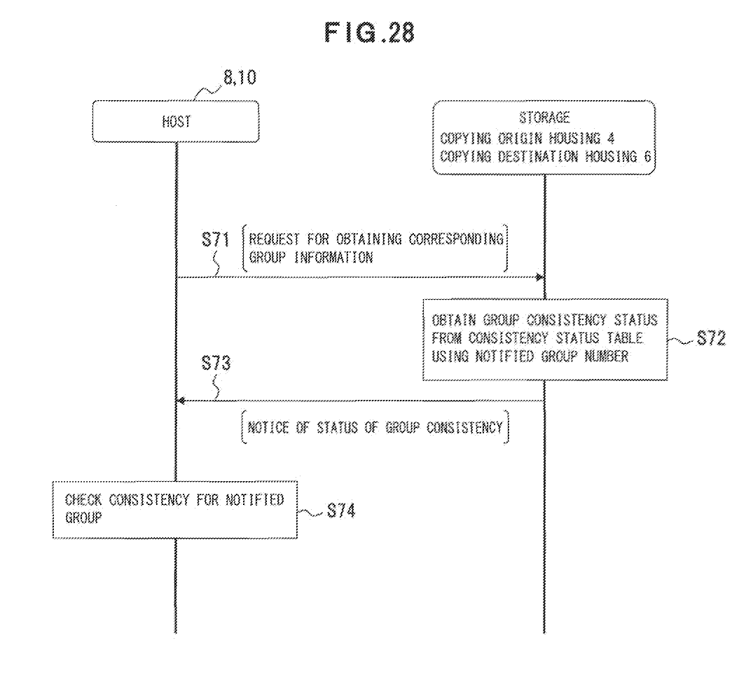

The checking of the status of the consistency will be described with reference to FIG. 28. FIG. 28 is a flowchart of the process sequence executed between a host and a storage. In FIG. 28, the same parts as those of FIG. 4 are given the same reference numerals.

The process sequence is the procedure of the consistency checking process executed between the host 8 or 10 and a storage, that is, the copying origin housing 4 or the copying destination housing 6, and is an example of the storage control method or the storage control program disclosed herein.

The status of the consistency of a group is constructed by the above processes. However, in this checking of the status of the consistency, as depicted in FIG. 28, a request for obtaining the corresponding group information is issued from the host 8 or 10 (S71).

The copying origin housing 4 or the copying destination housing 6 receives the request for obtaining the group information, and obtains the group consistency status from the consistency status table 122 using a group number notified (S72). Based on this, a notice of the status of the group consistency is issued from the copying origin housing 4 or the copying destination housing 6 to the host 8 or 10 that has issued a requirement for obtaining the group information (S73).

The host 8 or 10 receives the notice of the status of the consistency, and can check the consistency for the group notified (S74).

The REC command and its operation in the storage system 2 of the second embodiment will be described.

(1) START Command

When a host desires to start REC, the host notifies a storage of the copying management number, the group number, the mode, the copying origin LUN, the copying destination LUN, the copying origin object starting position and the copying destination object starting position. The storage stores the information of a designated destination, in the session management table in the cache area in the storage. Thereafter, the storage changes the status and the phase in the session management table respectively to “ACTIVE” and “Copying” and, thereafter, notifies the host of the completion of the execution of the command. Simultaneously, the storage starts transferring of the data at the copying origin to the copying destination.

(2) Suspend Command

When a host desires to disconnect REC, the host notifies a storage of the copying management number, the group number, the mode, the copying origin LUN, the copying destination LUN, the copying origin object staring position and the copying destination object starting position of an REC session that is desired to be disconnected for the storage. The storage checks whether the information of the designated destination is present in the session management table in the cache area in the storage. After confirming the presence, the storage changes the status of the session management table to “Suspend” and, thereafter, notifies the host of the completion of the execution of the command.

(3) Resume Command

When a host desires to reconnect REC, the host notifies a storage of the copying management number, the group number, the mode, the copying origin LUN, the copying destination LUN, the copying origin object staring position and the copying destination object starting position of an REC session that is desired to be reconnected for a storage. The storage checks whether the information of the designated destination is present in the copying session management table 120 in the memory 64 (for example, a cache area) in the storage. After confirming the presence, the storage changes the status of the session management table “Active” and, thereafter, notifies the host of the completion of the execution of the command.

When any writing is executed during the disconnection after responding to the command, transferring to the copying destination is started of the data that the writing is executed for.

(4) Stop Command

When the host 8 desires to suspend an REC session, the host 8 notifies a storage of the copying management number, the group number, the mode, the copying origin LUN, the copying destination LUN, the copying origin object staring position and the copying destination object starting position of the REC session that is desired to be discontinued for the storage. The storage checks whether the information of the designated destination is present in the session management table in the memory 64 (for example, a cache area) in the storage. After confirming the presence, the storage deletes the information in the session management table and, thereafter, notifies the host of the completion of the execution of the command.

As apparent from the second embodiment described above, features of the storage system or the storage control method are as follows.

(1) In the system to group-manage the volumes, the storage manages the data consistency of the group and, thereby, the host checks the content of the data. Therefore, the work load of checking whether the data has consistency can be omitted. Thereby, the duty resuming process executed after the occurrence of the disaster (RTO: Recovery Time Objective) can be shortened and the recovery work can be expedited.

(2) The storage can manage the data consistency as a group, as the “consistency status of the group”.

(3) The group status can be referred to from either one of the copying origin housing and the copying destination housing.

(4) When the host issues a command to each of the REC sessions that are grouped and, thereby, changes the status of the REC session, when each REC session becomes equivalent and the host changes the phase of the REC session, or when a disaster has occurred in a storage and the host changes the status of each REC session, the storage changes the “group consistency status”. The host 8 collects and checks the “group consistency status” of each group, and checks the group consistency based on the content of its status information. The consistency status table 122 is created in the memory 64 of the central control unit 50 of storage in the copying origin housing and the “group consistency status” changed is retained therein.

Thereby, the host 10 of the copying destination housing 6 checks the “group consistency status” and, thereby, can check the data consistency. Therefore, it can be determined whether the data is usable, without executing any complicated process.

When the host executes a process of checking the consistency for a plurality of REC sessions that are grouped to disconnect the REC, the status information is only obtained for the plurality of REC sessions that belong to the group, and one piece of “group consistency status” is only obtained from the hosts 8 and 10 for one group and be referred to. Therefore, the processing can be reduced and waste of resources can be prevented.

(5) The “group consistency status” is managed in the storage and, thereby, even an event having occurred in the storage can be immediately reflected on the group status information. Therefore, the time lag can be reduced between the hosts 8 and 10 in referring to the group status.

### Comparative Example

A comparative example is an exemplary configuration for the above embodiments in the case where the creation of the consistency table concerning the group and the monitoring of the consistency status are not executed. Though the load on the hosts becomes heavy in this comparative example, the content of the processes executed therein will be presented. Inconvenience in these processes is solved in the above embodiments.

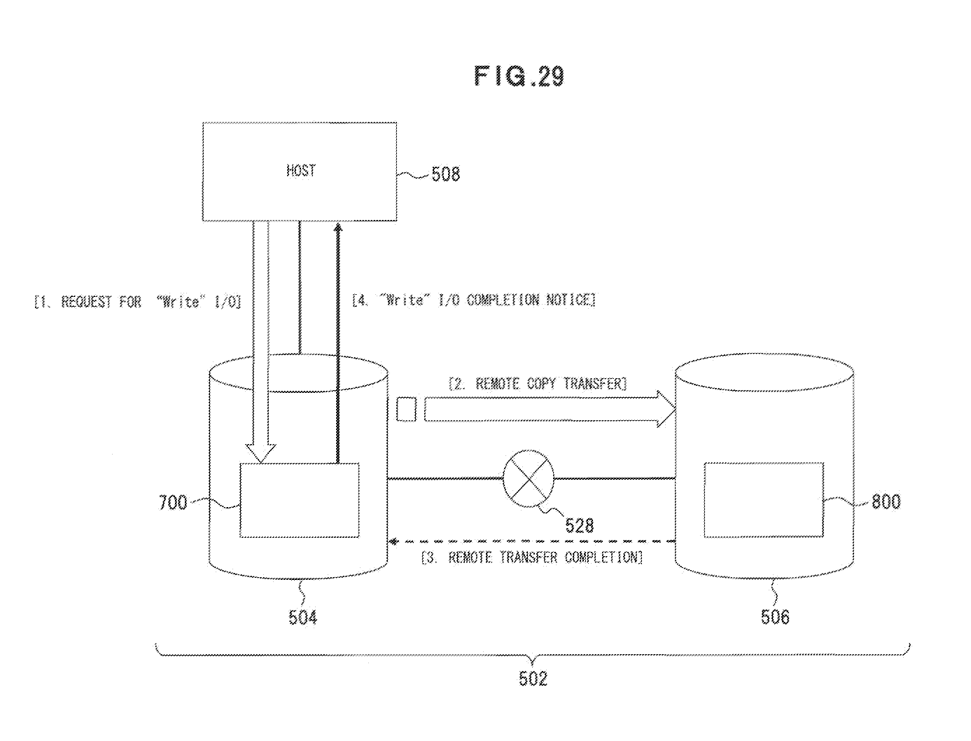

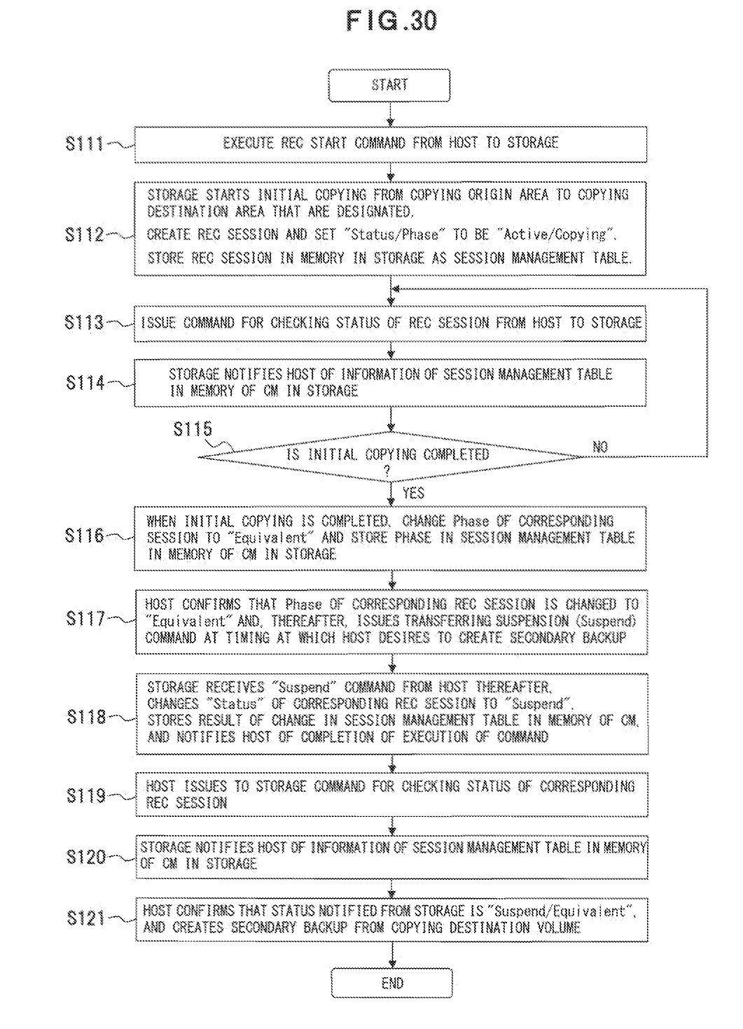

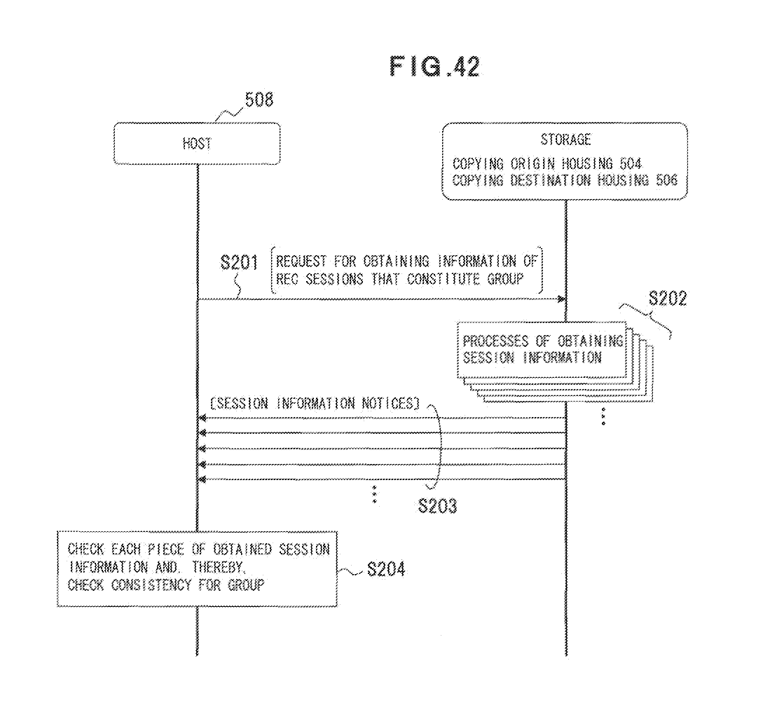

The comparative example will be described with reference to FIGS. 29 to 42. FIG. 29 is a diagram of a storage system that includes no consistency table. FIGS. 30 to 41 are diagrams of copying processes and their suffering from disasters. FIG. 42 is a diagram of process sequence in the comparative example.

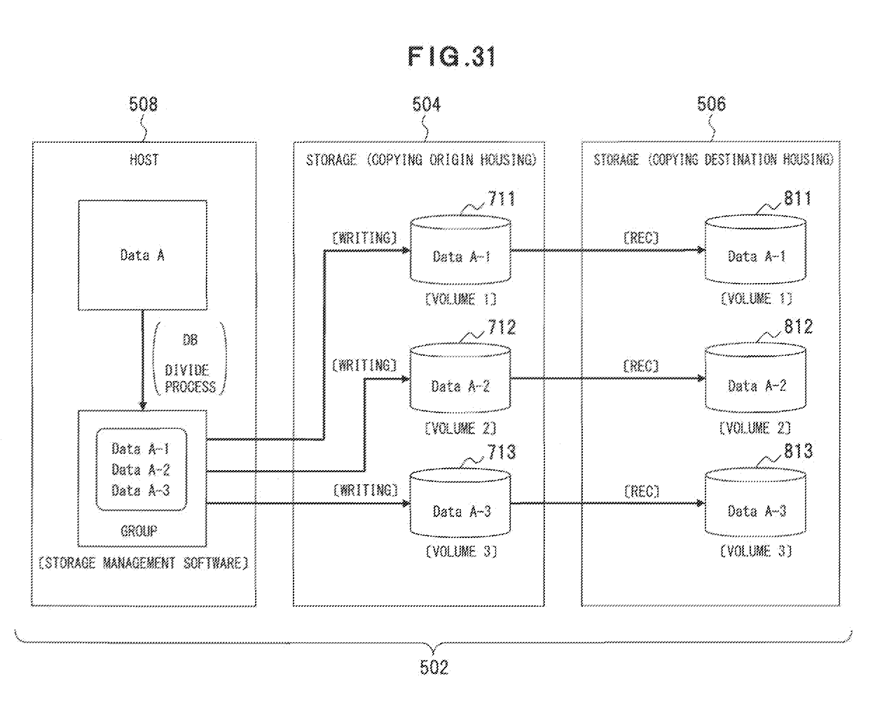

As depicted in FIG. 29, a storage system 502 includes a copying origin housing 504 and a copying destination housing 506 as storages. A host 508 is connected to the copying origin housing 504. The copying origin housing 504 and the copying destination housing 506 are connected to each other by a network 528. A copying origin volume 700 is installed in the copying origin housing 504 and a copying destination volume 800 is installed in the copying destination housing 506. The host 508 is implemented with, for example, storage management software as depicted in FIG. 31.

The storage system 502 includes the REC function. As above, the REC function is the data transferring function between the copying origin housing 504 and the copying destination housing 506 of different storage apparatuses and is the copying function of copying data in the whole volume or a portion of the volume from the copying origin housing 504 to the copying destination housing 506. As above, the REC function executes data transfer directly between the copying origin housing 504 and the copying destination housing 506 not through the host 508 and, therefore, a CPU in the host 508 is relieved from the data transfer and its load is reduced.

The unit of starting-up of the REC function is referred to as “session”. A CPU installed in the storage apparatus manages for each session a copying origin area, a copying destination area, the copy size, the status, the phase, and the copying type. For each session, the copying status is managed with Status and Phase combining these with each other. Therefore, types of copying status include an inactive status (Idle), an active status (Active), a copying suspended status (Suspend) and a failed status (Errsus). Types of Phase include a copying phase (Copying) and an equivalence status (Equivalent).

Types of changing of “Status” include a change according to a command instruction from the host 508 and a change executed by the storage apparatus itself due to occurrence of a failure to an apparatus etc. When a change is made according to a command instruction from the host, the change of “Status” is completed with a response to the command. “Phase” represents the state of backing up for the REC function.

In “Phase”, it is determined whether the status is in initial copying of the REC function or is the equivalence status. In “REC”, the change of “Phase” is operated in the storage apparatus and the change is not notified to the host.

When the host 508 checks “Phase” of the REC function, a status display command is executed. When the storage apparatus receives the status display command, the storage apparatus notifies the host 508 of “Status” and “Phase” of the REC session designated by the host 508.

The REC function manages on the memory an REC session management table that includes the above “Status” and “Phase”.

As to REC synchronization modes, the above storage system 502 has a synchronization mode like data securing (measure against disasters) that aims at solution thereof, as types of REC function. In this synchronization mode, writing into the copying destination volume 800 is executed synchronized with that of the copying origin volume 700. When a writing (Write) I/O is issued, an I/O completion report is sent to the host 508 after transferring (copying process) to the copying destination volume 800 has been completed. Because this is copying having synchronicity, the sequence of writing from the host 508 is also assured for the copying destination volume 800.

An I/O process procedure of the synchronization mode advances with: firstly, a request for “Write” I/O; secondly, remote copy transfer; and, thirdly, remote transfer completion, and comes to an end with, fourthly, a “Write” I/O completion notice.

In backing up using the REC function for a measure against disasters etc., an operation is present of secondarily backing up further from the copying destination volume 800 to another disk or a tape. In this case, it is confirmed that the phase of the copying destination volume 800 of the REC function is the above described “Equivalent”. This is because the copying destination volume 800 is incomplete data in “Copying” (initial copying) and, therefore, is unusable.

When data transfer is executed from the copying origin volume 700 to the copying destination volume 800 during the secondary backing up, the secondary backing up data is mixed with the data transferred from the copying origin volume 700 and becomes meaningless. Therefore, the creation of the secondary backup is executed when the transfer from the copying origin volume 700 to the copying destination volume 800 is suspended.

A procedure of creating the secondary backup from the copying destination volume 800 of the REC function will be described with reference to FIG. 30. FIG. 30 is a flowchart of the process procedure of creating the secondary backup.

This process procedure is as follows.

(1) An REC start command is executed from the host 508 to the storage (copying origin housing 504) (S111).

(2) The storage starts the initial copying from a copying origin area to a copying destination area that are designated (S112).

In this case, an REC session is created and “Status/Phase” is set to be “Active/Copying”. The REC session is stored in the memory in the storage as a session management table.

(3) A command for checking the status of the REC session is issued from the host to the storage (S113).

(4) The storage notifies the host 508 of information of the session management table in the memory of the management control unit in the storage (S114).

(5) Steps S113 and S114 are repeated until the initial copying is completed (S113 to S115).

(6) When the initial copying is completed, the phase of the corresponding session is changed to “Equivalent” and is stored in the session management table in the memory of the management control unit in the storage (S116).

(7) The host 508 confirms that the phase of the corresponding REC session is changed to “Equivalent” and, thereafter, issues a transferring suspension (Suspend) command at the timing at which the host 508 desires to create the secondary backup (S117).

(8) The storage apparatus receives the “Suspend” command from the host 508, thereafter, changes the “Status” of the corresponding REC session to “Suspend”, stores the result of the change in the session management table, and notifies the host 508 of the completion of the execution of the command (S118).

(9) The host 508 issues to the storage a command for checking the status of the corresponding REC session (S119).

(10) The storage notifies the host 508 of the information of the session management table in the storage (S120).

(11) The host 508 confirms that the status notified from the storage is “Suspend/Equivalent”, and creates a secondary backup from the copying destination volume 800 (S121). Thereby, the process comes to an end.

In backing up a plurality of RECs, for this database system etc., the data consistency may be necessary not only for each volume but also for a plurality (group) of volumes as a unit. This is the case, for example, where the data of the data system is written into a plurality of volumes distributing the data to the volumes and, when the volumes in the group are not fully present, the function of the database system is not achieved.

To check the copying status of the plurality of REC sessions, the checking is executed to each of the plurality of sessions of the status and the phase of the REC sessions as described above.

In this case, the host groups the REC sessions and issues a status checking command to each of the REC sessions that constitute the group. The host 508 collects the results of the REC sessions and checks the copying destination volumes as a group.

For the host 508 to check the status of the copying destination for the group, the host 508 checks the status and the phase of REC sessions of each of the volumes 700 and 800 for the number of times corresponding to the number of sessions that constitute the group.

In the comparative example, the host 508 also retains the status list of the REC sessions in the group as a first problem.

For the host 508, the work load of checking the statuses and the phases of the REC sessions increases and the processing time therefor increases as the number of REC sessions that constitute the group increases, as a second problem.

The status and the phase of each of the REC sessions may be shifted due to internal processing or detection of abnormality of the storage. The time for the checking process is expected to increase as the number of REC sessions that constitute the group increases when no consistency management is executed by the management table. Inconvenience is also expected that the status and the phase are changed due to internal processing or detection of abnormality of the storage during the checking by the host 508 of the status of the REC sessions in the group. In addition, when the status of the REC is changed due to internal processing or detection of abnormality of the storage, the change of the status is not notified to the host.

Therefore, it is expected that the status of each REC in the group retained by the host 508 and the status of each REC in the group managed in the storage are different from each other, as a third problem.

The data at the copying destination can further be backed up for the REC sessions that are grouped (the consistency is established as the group at the copying destination) when all the REC sessions are in “Active/Equivalent” or “Suspend/Equivalent”. When a disconnection command is executed for each of the volumes, the timings of disconnecting become different from each other.

The case will be described where, in the storage system 502, when a failure occurs in a volume of a storage, remote transferring of the volume alone is stopped and remote transferring of the other volumes is continued.

Even when the status of each of all the REC sessions in the group is “Suspend/Equivalent”, the data in the copying destination housing 506 that is a backup site does not establish the consistency of the copying destination volume 800 over the plurality of volumes and the consistency as the group may be lost.

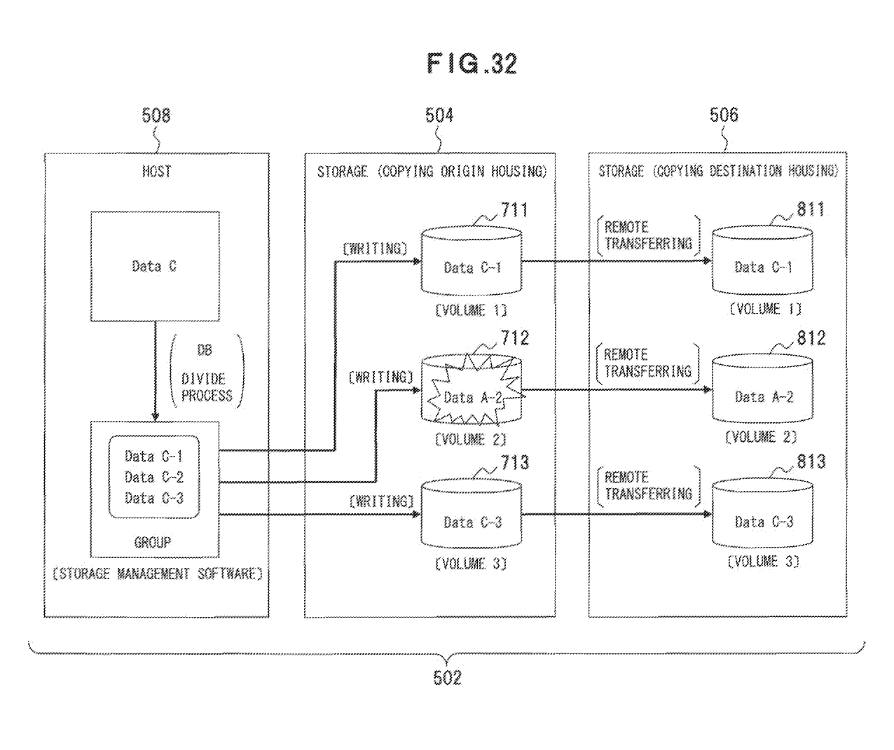

FIG. 31 depicts the normal copying state and FIG. 32 depicts the case where the copying suffers from a disaster. As depicted in FIG. 31, writing processes are executed for a database (DB) of the host 508 in order of those for data A, data B and data C. FIG. 32 depicts an event of occurring a failure in a volume 712 (volume 2) during the writing for the data C. Because the failure has occurred in the volume 2 during the writing process for the data C, the writing of “data C-2” into the volume 2 is unsuccessful while the writing into the volumes 1 and 3 is successful.

In the system of the comparative example, the storage does not correlate the pieces of data with the volumes. Therefore, even when the writing of “data C-2” into the volume 2 is unsuccessful, the volumes 1 and 3 are normal and, therefore, the writing of the data C is permitted. Therefore, the processes are advanced even though a portion of the data that is divided is lacking. Therefore, the consistency of the data in the copying destination housing 506 is not established.

Therefore, a process is present of immediately stopping remote transferring of all the volumes in the group when the plurality of volumes are managed as a group and remote transferring of one of the volumes is not executed.

These processes enable collective disconnection as a group at a timing or collective disconnection of RECs in the group at the time when a fault occurs.

In this case, when the status of the session of each REC in the group is checked, it turns out that all the session statuses are “Suspend”. At this time, the host requests the storage apparatus to obtain the status of each of all the REC sessions that belong to the group, checks the status and the phase of each of the REC sessions delivered from the storage apparatus, and checks the consistency.

The case is present where, when the site of the copying origin housing 504 suffers from a disaster and a duty is switched so as to be executed in the site of the copying destination housing 506, the host on the copying destination site does not determine whether the data of the copying destination storage apparatus has consistency. This is the case where the path between the housings is disconnected when: only an REC session becomes abnormal due to a failure to a disk of the storage apparatus; the corresponding group is disconnected; thereafter, the failed disk is recovered; and the REC session that has been abnormal is restarted. Though presence or absence of the consistency can be determined by checking the status of copying sessions for each volume, whether each group has consistency is not determined, as a fourth problem.

(1) It is assumed that three REC sessions are present in a storage. It is set forth as a premise that the host executes therein status management of the REC sessions in the group for the three REC sessions. In this case, the status managing means in the host does not matter.

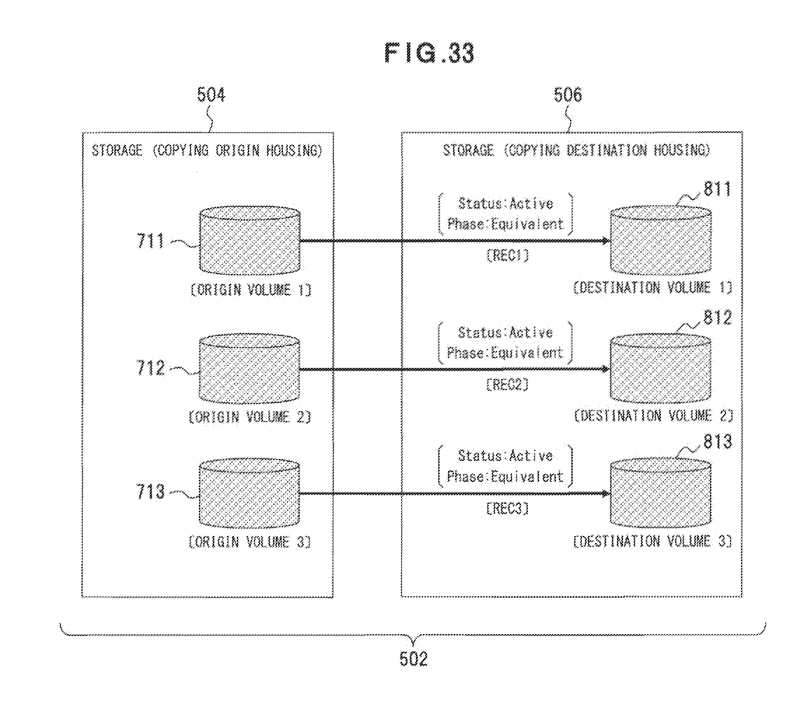

As depicted in FIG. 33, the status of each of the REC synchronized sessions is “Active” and the phase thereof is “Equivalent” and, therefore, this is the state where writing into the copying origin apparatus is immediately reflected on the copying destination apparatus and it can be assured that the contents of the disks of the copying origin apparatus and the copying destination apparatus are same.

When the status and the phase of each of all the REC sessions in the group G are “Active/Equivalent”, equivalence of the copying origin apparatus and the copying destination apparatus is established for all the REC sessions. This is the state where the consistency is secured also as the group.

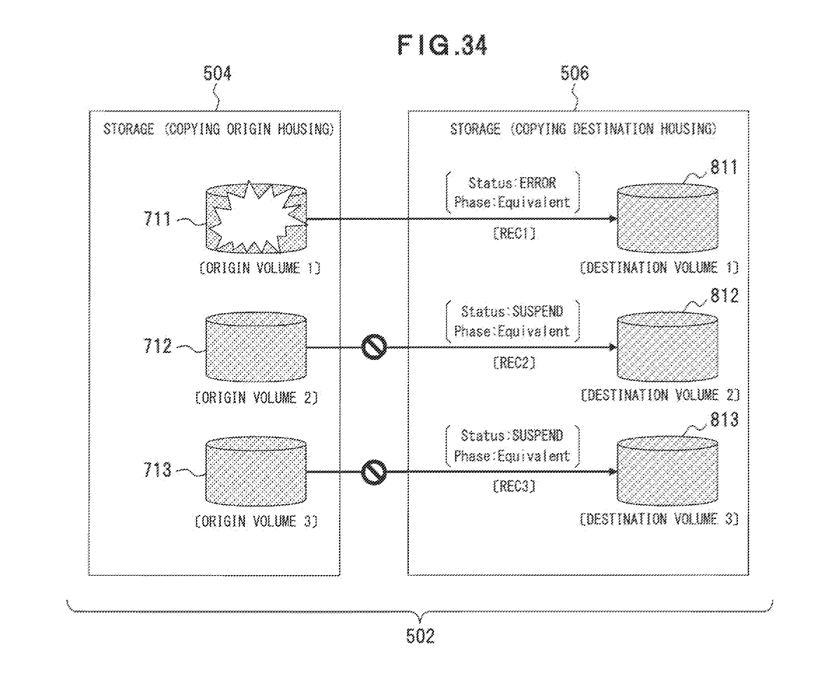

(2) During REC synchronized mode sessions that are grouped, when a failure occurs in a volume, the storage disconnects all the REC sessions in the same group (FIG. 34).

When the status and the phase of each of all the sessions in the group respectively are “Active” and “Equivalent” at a time before the occurrence of the failure, the identity of the origin volume and the destination volume with each other at the time when the failure has occurred is secured. Even when the data is written at the time of or after the occurrence of the failure, the data is not transferred to the copying destination apparatus and, therefore, the consistency in the group is secured. In this case, the writing from the host to the copying origin apparatus is stopped due to the failure.

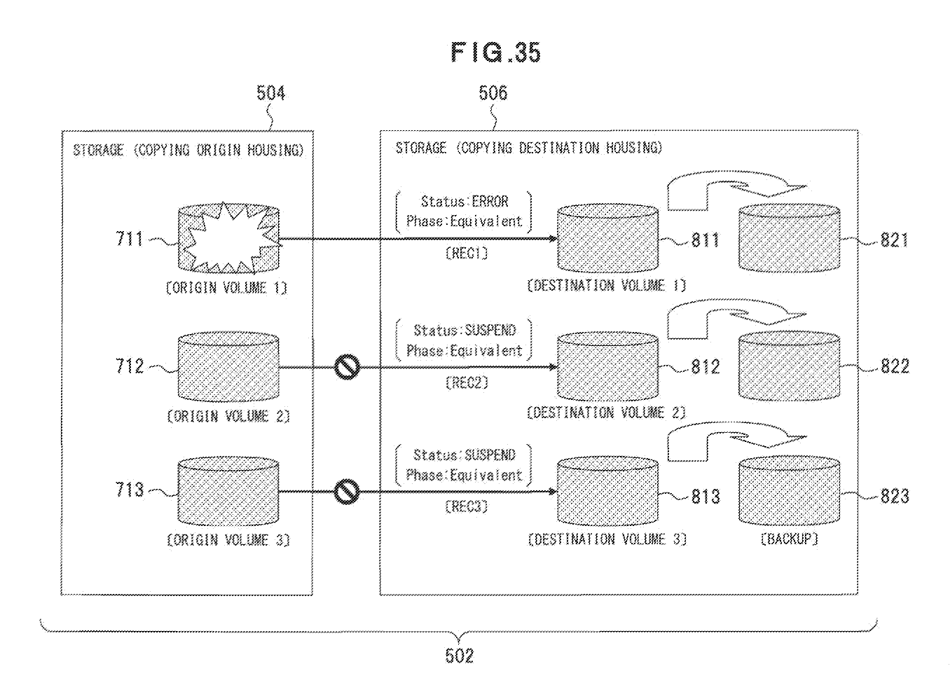

(3) As depicted in FIG. 35, when the consistency of the group can be confirmed, a backup is produced from the copying destination apparatus housing to be used for recovery etc.

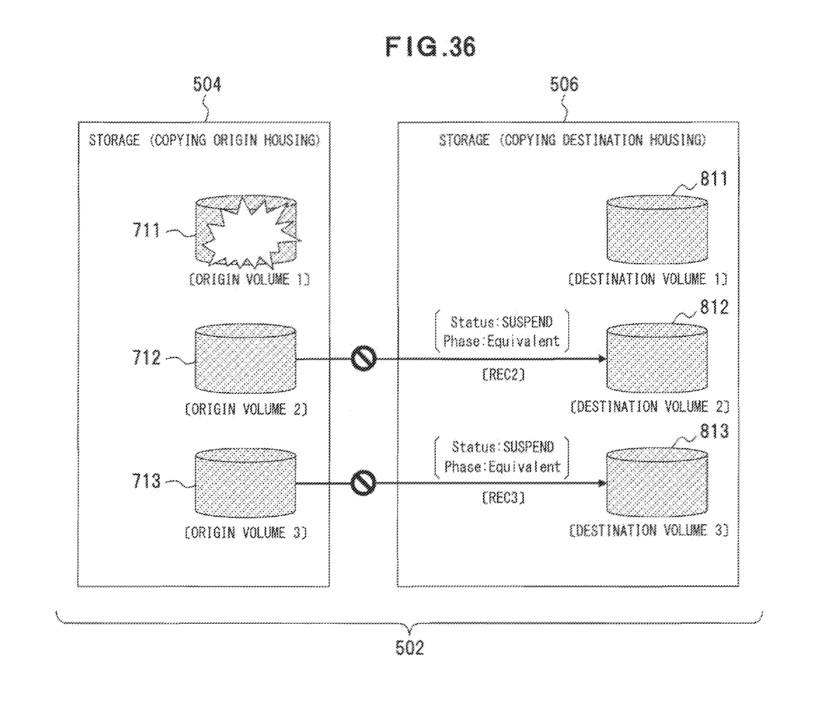

(4) The failed disk in the copying origin apparatus housing is recovered. Therefore, as depicted in FIG. 36, the setting of the REC that has the error is deleted. The time when the setting of an REC 1 is deleted is represented.

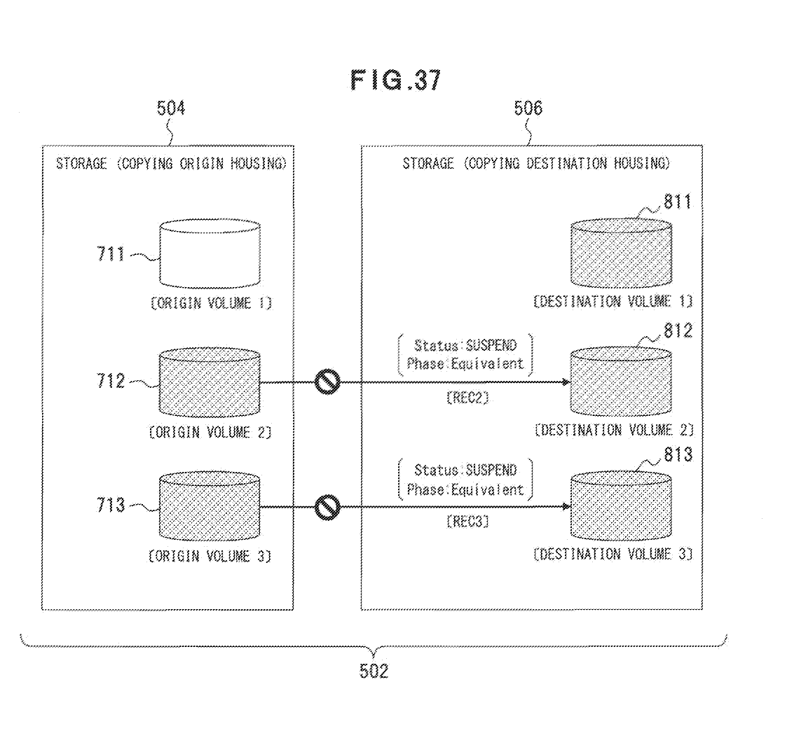

(5) As depicted in FIG. 37, after deleting the REC 1, a copying origin volume 1 that has the failure is replaced. By replacing the origin volume 1, the data of the origin volume 1 is initialized.

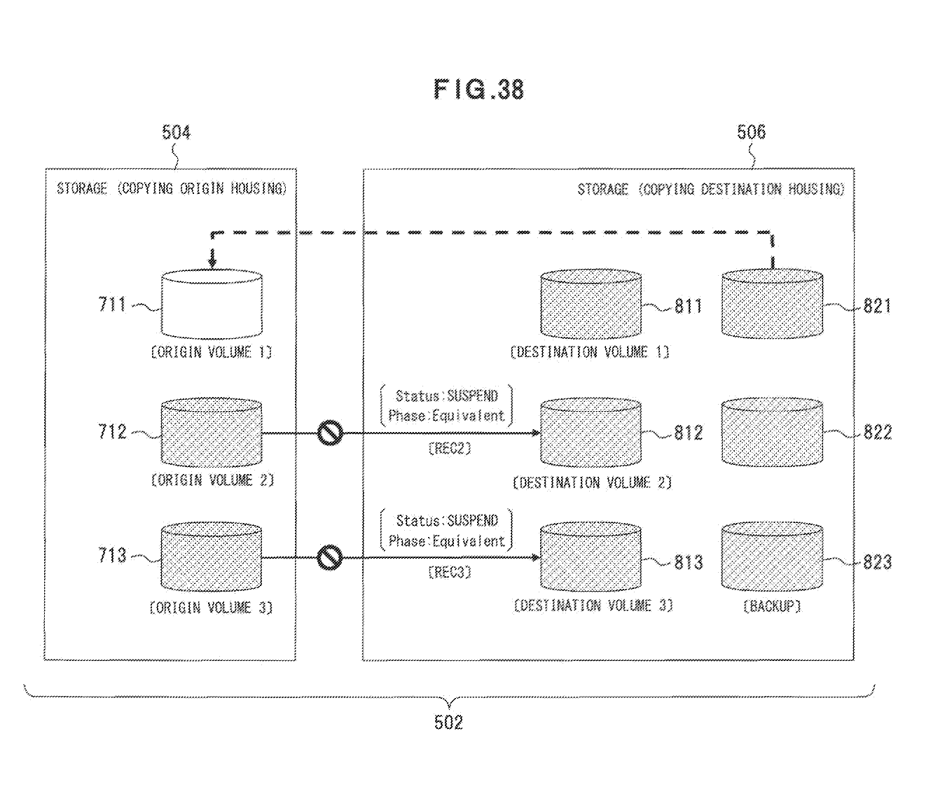

(6) As depicted in FIG. 38, the baked-up data is recovered for the copying origin volume 1 that is recovered. The recovering means does not matter.

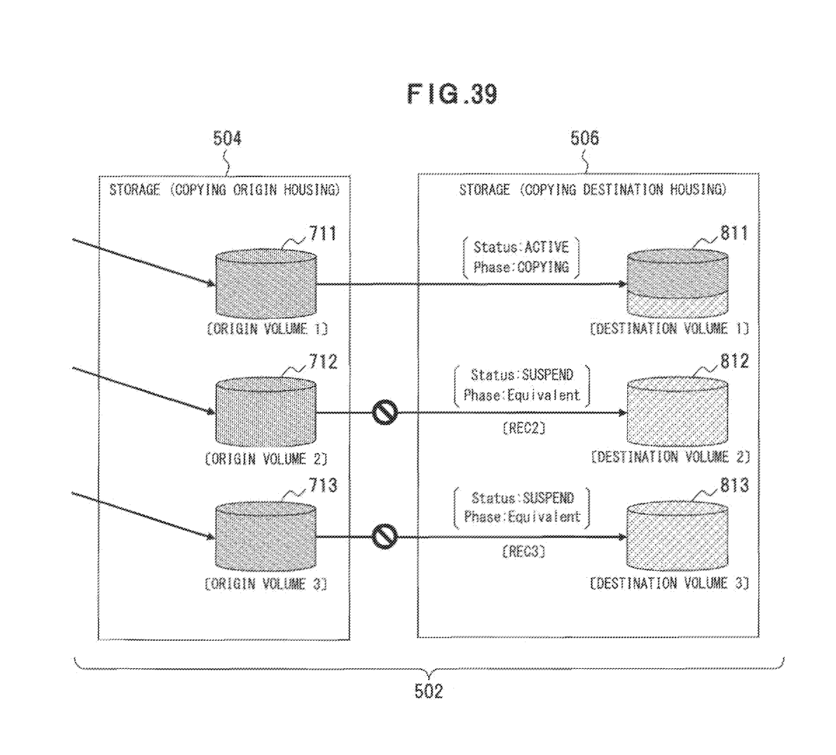

(7) As depicted in FIG. 39, when the backing up for the copying origin apparatus is completed, an access is permitted from the host to the copying origin apparatus housing because the copying origin apparatus housing is recovered. Simultaneously, because the REC session is deleted, the REC 1 is again started from the copying origin apparatus volume 1 to a copying destination apparatus volume 1. When the REC is started, the data of the copying origin apparatus volume is backed up in the copying destination apparatus.

In FIG. 39, because the writing into the copying origin apparatus housing is permitted, new data is retained in the copying origin apparatus. For the RECs 2 and 3, a recovering method is taken that is a method of maintaining the status of each of the RECs 2 and 3 to be “Suspend” until the backing up of the REC 1 is completed.

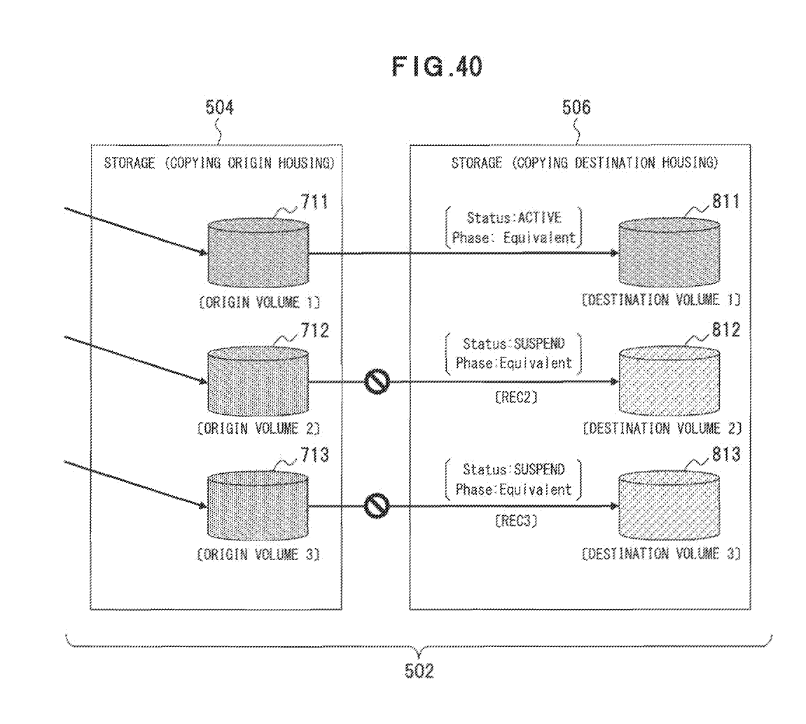

(8) As depicted in FIG. 40, the system is in the state where the initial copying of the REC 1 is completed and the equivalence of the copying origin apparatus and the copying destination apparatus is established.

In this state, for the REC 1, the equivalence of the copying origin volume and the copying destination volume is established. However, for the RECs 2 and 3, the content of the data of the copying destination apparatus is that of the time when the failure has occurred and the latest data of the copying origin is not reflected thereon.

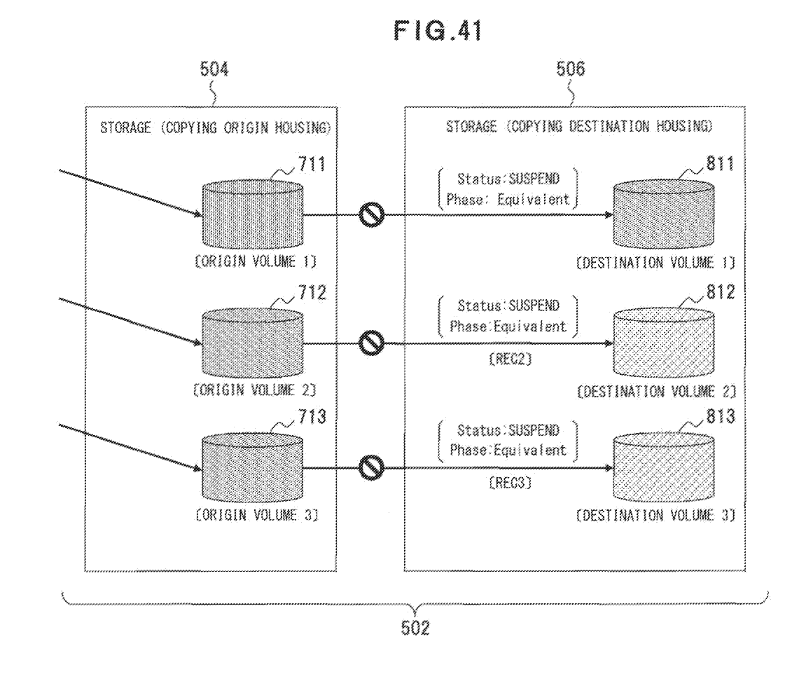

(9) When the path between the housings of the storage apparatuses is disconnected in the state depicted in FIG. 40, all the REC sessions are in “SUSPEND” as depicted in FIG. 41.

When the status of each REC session is checked in this state using a status display command for each session, the session status is “SUSPEND”, and this is the status where the states of the copying origin apparatus and the copying destination apparatus are separated from each other. The phase of each of all the sessions is “Equivalent” and this is the status where the status of equivalence is secured of the copying origin apparatus and the copying destination apparatus at the moment at which the status becomes “SUSPEND”.

This state is not distinguished from the state depicted in FIG. 34 based on the determination of the status and the phase of each session. However, the time band during which the status of the REC 1 becomes “SUSPEND” and that of the RECs 2 and 3 are different from each other and, therefore, the consistency of the data of the copying destination is not established.

A consistency status checking process for each group in the comparative example will be described with reference to FIG. 42. FIG. 42 is a diagram of process sequence of the consistency status checking process for each group in the comparative example.

In the comparative example, a request for obtaining information of the REC sessions that constitute the group is issued from the host 508 to the storage (S201). The storage receives this request and executes a plurality of processes each of obtaining session information for each REC session (S202). Based on these processes, many session information notices are issued and, thereby, pieces of session information are notified to the host 508 (S203). The host 508 checks the plural pieces of session information obtained as the consistency checking process and, thereby, checks the consistency for the group (S204). In this process procedure, the process load on the host 508 is heavy and loss concerning time is also tremendous.

For the first to the fourth problems and the consistency checking process described in the comparative example, the storage system and the storage control method of the above embodiments solve all of the above by creating the consistency table that indicates the status of the group, and managing and notifying the consistency status. In the comparative example (FIGS. 31 to 41), the reference numerals 711 to 713, 811 to 813 and 821 to 823 denote the volumes as apparently indicated in each of the drawings.

### [c] Other Embodiments

(1) Though the storing units 14 and 24 in the storage are caused to create the status information storing areas 15 and 25 and the consistency status table 122 in the above embodiments, the invention is not limited to the above. The storing unit of each of the hosts 8 and 10 may similarly be caused to create the status information storing areas 15 and 25 and the consistency status table 122 and may monitor and manage the status information synchronized with the storage.

(2) Though the consistency status table is created in the storage triggered by the grouping of the plurality of copying sessions in the above embodiments, the invention is not limited to the above. As to the trigger that is the grouping of the copying sessions, the consistency status table may be created in advance when the grouping is expected. In this case, the consistency status information may be stored in the status table.

According to the storage system or the storage control method disclosed in “DESCRIPTION OF EMBODIMENTS”, the following effects can be obtained.

(1) A system can be constructed whose storage group-manages its volumes.

(2) In synchronized backing up executed between storages, a storage can group the plurality of volumes and, thereby, the consistency of the data can be secured.

(3) A storage can manage the data consistency of a group, and a host does not execute conventional process of checking whether the data has consistency and, therefore, the load of checking the content of the data etc., can be omitted.

(4) Even when the system suffers from a disaster, the duty resuming process (RTO) therefor is reduced and this contributes to expediting of the recovery work for the system.

Technical ideas extracted from the embodiments including the example described above will then be listed. The technical ideas of the present disclosure may be comprehended at various levels and variations ranging from higher to lower conceptions and the present disclosure is not limited to the following description.

A storage system to copy data from a copying origin to a copying destination includes a storing area creating unit that causes a storing unit in a storage to create a status information storing area to have status information stored therein, based on grouping, the grouping being executed on data that is divided into plural pieces, the grouping being executed when the divided data is stored in the storage, wherein the status information of each group is stored in the status information storing area that is created by the storing unit.

The above storage system may preferably include a notifying unit that notifies the status information, wherein the notifying unit may notify the status information to a host that is connected to the copying origin or the copying destination.

In the above storage system, preferably, the status information storing area may be correlated by group information that is stored in a management table created in the storing unit.

A storage control method of copying data from a copying origin to a copying destination includes causing a storing unit in a storage to create a status information storing area to have status information stored therein, based on grouping, the grouping being executed on data that is divided into plural pieces, the grouping being executed when the divided data is stored in the storage, storing the status information of each group in the status information storing area that is created by the storing unit.

The above storage control method may preferably include notifying the status information to a host that is connected to the copying origin housing or the copying destination housing.

The program implementing the embodiments may be recorded on computer-readable media comprising computer-readable recording media. The program implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present inventions have been described in detail, it should be understood that the various changes, substitutions, and alterations could be made hereto without departing from the spirit and scope of the invention.

As above, the embodiments of the storage system and the storage control method have been described. However, the present invention is not limited to the above and various modifications and changes can certainly be made thereto by those skilled in the art based on the summary of the present invention that is described in the scope of the claims or that is disclosed in “DESCRIPTION OF EMBODIMENTS” and, needless to say, such modifications and changes are encompassed in the scope thereof.

What is claimed is:

1. A storage system to copy data from a copying origin to a copying destination, comprising:
a storing area creating unit that causes a storing unit in a storage to create a status information storing area to have status information stored therein, based on grouping, the grouping being executed on data that is divided into plural pieces, the grouping being executed when the divided data is stored in the storage, wherein
the status information of each group is stored in the status information storing area that is created by the storing unit.

2. The storage system of claim 1, further comprising:
a notifying unit that notifies the status information, wherein
the notifying unit notifies the status information to a host that is connected to the copying origin housing or the copying destination housing.

3. The storage system of claim 1, wherein
the status information storing area is correlated by group information that is stored in a management table created in the storing unit.

4. A storage control method of copying data from a copying origin to a copying destination, comprising:
causing a storing unit in a storage to create a status information storing area to have status information stored therein, based on grouping, the grouping being executed on data that is divided into plural pieces, the grouping being executed when the divided data is stored in the storage; and
storing the status information of each group in the status information storing area that is created by the storing unit.

5. The storage control method of claim 4, further comprising:
notifying the status information to a host that is connected to the copying origin or the copying destination.
